(19) United States
(12) Patent Application Publication
(10) Pub. No.: US 2025/0077310 A1
(43) Pub. Date: Mar. 6, 2025

(54) SYSTEMS AND METHODS FOR GENERATING USER EVENT PREDICTIONS

(71) Applicant: Wells Fargo Bank, N.A., San Francisco, CA (US)

(72) Inventors: Debashis Ghosh, Charlotte, NC (US); Maria Chiarenza, Charlotte, NC (US); Srinivas R. Doki, Charlotte, NC (US); Chinimilli Vara Maheswara Satish Kumar, Bengaluru (IN); Michael Restrepo, Charlotte, NC (US); Kurt D. Newman, Charlotte, NC (US)

(21) Appl. No.: 18/456,847

(22) Filed: Aug. 28, 2023

(51) Int. Cl. G06F 9/54; G06Q 40/06

(52) U.S. Cl. CPC G06F 9/54; G06Q 40/06

(57) ABSTRACT

Systems, apparatuses, methods, and computer program products are disclosed for providing a resource allocation recommendation message to a user. An example method includes identifying a predicted liquid asset influx for the user and determining a current resource metric. The method further includes generating a resource allocation recommendation message that comprises one or more resource allocation recommendations that are each associated with (i) a user account of the one or more user accounts associated with the user or a new user account type and (ii) a resource allocation value. The method may further include providing the resource allocation recommendation message.

### BACKGROUND

Modern systems may utilize data to provide services. The data relevant to a particular implementation may exist in a plurality of data sources throughout a distributed system.

### BRIEF SUMMARY

Communication systems facilitate a broad array of interactions between devices and users thereof. As part of these interactions, the devices may obtain data from one or more data sources. The data may drive the performance of computer-implemented services based on the data. In some embodiments, the data may be associated with a user or a collection of users (e.g., a family). User data may be available or sourced from a variety of data sources but may require additional processing. Nevertheless, such data may include comprehensive and detailed information that may be leveraged to solve a variety of complex issues.

For example, users maybe the recipient of funds due to the occurrence of an event, which they may or may not be expecting. By way of particular example, a user may receive a deposit of funds from his/her employer due an annual bonus event. However, the user may be unaware that this event has occurred or may be unaware of the amount of funds he/she received as a bonus, particularly in an instance in which the funds were deposited automatically, such as via direct deposit. As another example, users may be unaware of when they have reached a particular contribution limit event, such as reaching a 401(k) contribution limit or the like. Once said contribution limit has been reached, the user's net income may increase due to funds no longer being contributed to the 401(k) account. However, the user may be unaware that this event has occurred and/or may be unaware of how this has affected his/her net income. Furthermore, users may be unaware of the various metrics and/or parameters of their overall contributions into various accounts, particularly when a user has multiple accounts that correspond to the same account type (e.g., multiple 401(k) accounts).

This is problematic for several reasons. As an initial matter, the user may be unaware of that an event has occurred in the first place such that the user is additionally unaware of the excess funds and/or amount of funds in his/her account. As such, the user may unknowingly allow these funds to remain in a same account in which they were initially deposited, which may be suboptimal for the user. For example, a user may have direct deposit linked to his/her checking account such that any employer deposited funds are deposited to this checking account. However, funds from an event (e.g., a bonus, reaching a contribution limit, etc.) may also be deposited into the checking account. A user may instead wish to put these funds into a savings account, where they may reap more benefit from the funds. However, the lack of insight into the event occurrence and event details may prevent the user from doing so. Furthermore, even in an instance in which a user is aware that the event has occurred, the user may be unaware of the amount of funds that are safe to save. For example, in an instance in which the event is a contribution limit event, the additional funds may occur in regular paycheck deposits of the user. As such, the user may be unaware of the amount of funds that are safe to save as this would require the user to know the portion of the funds deposited that are attributed to the contribution limit event. Additionally, users may be unaware of how best to allocate these funds and

In contrast to the above, example embodiments described herein provide a user with an asset savings notification such that the user may be provided with an indication of a predicted event, a corresponding event time frame, and a predicted liquid asset influx indicative of a predicted amount of funds that correspond to the event. In this way, users may be made aware of incoming funds and may be able to effectively plan for receipt of these funds. In some embodiments, users may provide instructions to preemptively allocate the predicted liquid asset influx to a particular user account or create a new user account for the predicted liquid asset influx. As such, the user may optimize the benefit provided by the predicted liquid asset influx by rerouting these select funds from a default account (e.g., the account associated with direct deposit) to an account of the user's choosing. In some example embodiments, the user may be provided with the asset savings notification prior to the predicted event occurring. As such, the user may be provided additional time to plan how to use and/or reroute the predicted liquid asset influx to best serve his/her needs.

Additionally, example embodiments described herein may be uniquely positioned to leverage various sources of data, such as an individual user's data (e.g., internal source data), employer organization data (e.g., organization attributes), and/or other employee data (e.g., a similar user subset), to determine a user event prediction and a predicted liquid asset influx for the event. By leveraging these various data sources, the event prediction accuracy and/or predicted liquid asset influx accuracy may be increased such that the user may be provided with an overall more accurate asset savings notification. In some embodiments, user internal source data, such as income data sourced from one or more of direct deposit documents, paycheck documents, or self-reported income for the user, may be used to determine one or more parameters and/or metrics for user. For example, the user internal source data may be processed to determine user contribution metrics and/or user account metrics. These user contribution metrics and/or user account metrics may be used to determine the user event prediction, determine the predicted liquid asset influx, and/or generate a user contribution metric set. In some example embodiments, the user contribution metric set may be indicative of a user's overall contributions to particular contribution field. The user contribution metric set may be included in the asset savings notification such that the user may be made aware of their overall contributions to each contribution field and thus, gain further insight into his/her financial health that is not conventionally available. By leveraging information from these variety of sources, such as user internal source data, example embodiments disclosed herein allow for the determination of user contribution metrics for each contribution field to be determined such that the user may be provided with a holistic overview of his/her overall contributions, contributions to-date, and/or contribution limits.

Additionally, the user internal source data may allow for the identification of an employer organization of the user. Example embodiments disclosed herein may further identify employer organization attributes that may be used to determine the user event prediction and/or predicted liquid asset influx. Additionally, or alternatively, one or more other users associated with the employer organization may be identified. A similar user subset may be identified from the one or more other user and the data associated with the similar user subset may be anonymized and used to determine the user event prediction and/or predicted liquid asset influx. A similar user subset may include one or more users who are selected from a set of other users associated with the same employer organization as the user. In particular, users from the similar user subset may include users who share at least one user attribute with the user of interest. As such, the similar user subset may narrow down the number of users from all users within an employer organization to only users who are determined to be similar to the user of interest, thereby reducing associated computational processing requirements while maintaining prediction accuracy.

In some embodiments, example embodiments disclosed herein may further provide the user with a user contribution metric set that may be indicative of the user contribution metrics for a given contribution field. The user contribution metric set may be included in the provided asset savings notification such that the user may also be made aware of his/her overall contributions to a particular contribution field and may better assess future allocation to each contribution field and/or gain insight into their current contribution metrics.

Additionally, in some example embodiments, it may be advantageous to provide a user with a resource allocation recommendation. A resource allocation recommendation may provide users with recommendations on how to optimize their predicted liquid asset influx such that the user may alleviate the analysis of how to optimize the allocation of the predicted liquid asset influx. In some example embodiments, supplemental information may be generated for the resource allocation recommendation, which may provide the user with an explanation of why a particular allocation of a portion of the funds of the predicted liquid asset influx was determined to be optimal for a particular account. As such, the user may gain additional insights into why a particular recommendation was determined. Additionally, a forecast resource metric set may also be determined for the user based on the resource allocation recommendation. The forecast resource metric set may provide the user with a prediction of how his/her accounts may be influenced or affected should the user choose to follow the resource allocation recommendation.

Additionally, embodiments disclosed herein may cause one or more predictive actions to take place. In some example embodiments, a predictive action may be monitoring for the predicted liquid asset influx within a user account on behalf of the user and automatically re-allocating portions of the predicted liquid asset influx to corresponding accounts as outlined in the resource allocation recommendation. In particular, a user may provide authorization and/or feedback that grants the system permission to follow the resource allocation recommendation. As such, the system may automatically reallocate the predicted liquid asset influx funds to corresponding accounts such that the user does not need to continuously monitor his/her account. In doing so, example embodiments disclosed herein may allow for real-time re-allocation of a portion of a predicted liquid asset influx. In some embodiments, the re-allocation of a portion of a predicted liquid asset influx may allow the system to bypass conventional processes of first clearing and processing a payment transfer to an original account and may instead, re-route portions of the predicted liquid asset influx to the appropriate accounts automatically, where they then may be processed and cleared. Thus, embodiments described herein may improve the process of asset transfer by reducing overall processing requirements and thus, conserving overall computational resources.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used for generating and provides an asset savings notification and/or a resource allocation recommendation.

FIG. 2 illustrates a schematic block diagram of example circuitry embodying a system device that may perform various operations in accordance with some example embodiments described herein.

FIG. 3 illustrates an example flowchart for generating and providing an asset savings notification, in accordance with some example embodiments described herein.

FIG. 4 illustrates an example flowchart for performing an analysis of internal source data to determine a user event prediction and/or determine a predicted liquid asset influx, in accordance with some example embodiments described herein.

FIG. 5 illustrates another example flowchart determining the user event prediction and/or the predicted liquid asset influx based on an identified employer organization, in accordance with some example embodiments described herein.

FIG. 6 illustrates an example flowchart for generating and providing a resource allocation recommendation, in accordance with some example embodiments described herein.

FIG. 7 illustrates an example flowchart for determining one or more user account metrics and/or user contribution metrics, in accordance with some example embodiments described herein.

FIG. 8 illustrates an example user interface depicting an asset savings notification as used in some example embodiments described herein.

FIG. 9 illustrates an example user interface depicting an asset savings notification as used in some example embodiments described herein.

FIG. 10 illustrates an example user interface depicting a resource allocation recommendation as used in some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” or “device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

### System Architecture

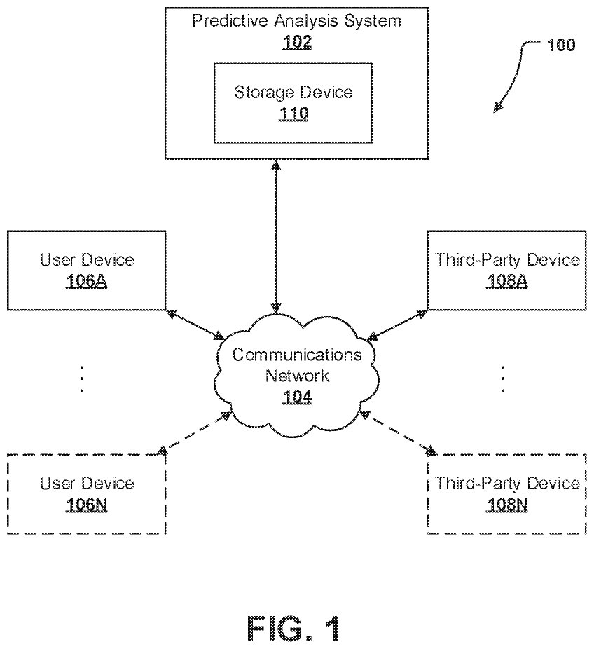

Example embodiments described herein may be implemented using any of a variety of computing devices or servers. To this end, FIG. 1 illustrates an example environment 100 within which various embodiments may operate. As illustrated, the predictive analysis system 102 may receive and/or transmit information via communications network 104 (e.g., the Internet) with any number of other devices, such as one or more of user devices 106A-106N and/or third-party devices 108A-108N.

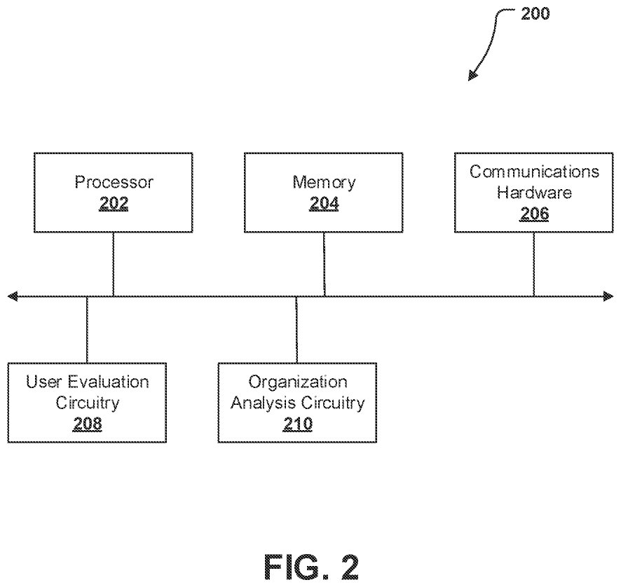

The predictive analysis system 102 may be implemented as one or more computing devices or servers, which may be composed of a series of components. Particular components of the predictive analysis system 102 are described in greater detail below with reference to apparatus 200 in connection with FIG. 2.

In some embodiments, the predictive analysis system 102 further includes a storage device 110 that comprises a distinct component from other components of the predictive analysis system 102. Storage device 110 may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 104). Storage device 110 may host the software executed to operate the predictive analysis system 102. Storage device 110 may store information relied upon during operation of the predictive analysis system 102, such as various machine learning models or other models that may be used by the predictive analysis system 102, data and documents to be analyzed using the predictive analysis system 102, or the like. In addition, storage device 110 may store control signals, device characteristics, and access credentials enabling interaction between the predictive analysis system 102 and one or more of the user devices 106A-106N or third-party devices 108A-108N.

The one or more user devices 106A-106N and the one or more third-party devices 108A-108N may be embodied by any computing devices known in the art. The one or more user devices 106A-106N and the one or more third-party devices 108A-108N need not themselves be independent devices, but may be peripheral devices communicatively coupled to other computing devices. In some embodiments, the one or more third-party device 108A-108N may be associated with a particular entity. For example, third-party devices 108A-108C may be associated with a credit bureau, third-party devices 108D-108E may be associate with a financial institution, and third-party devices 108F-108G may be associated with the Internal Revenue Service.

Although FIG. 1 illustrates an environment and implementation in which the predictive analysis system 102 interacts indirectly with a user via one or more of user devices 106A-106N and/or third-party devices 108A-108N, in some embodiments users may directly interact with the predictive analysis system 102 (e.g., via communications hardware of the predictive analysis system 102), in which case a separate user devices 106A-106N and/or third-party devices 108A-108N may not be utilized. Whether by way of direct interaction or indirect interaction via another device, a user may communicate with, operate, control, modify, or otherwise interact with the predictive analysis system 102 to perform the various functions and achieve the various benefits described herein.

### Example Implementing Apparatuses

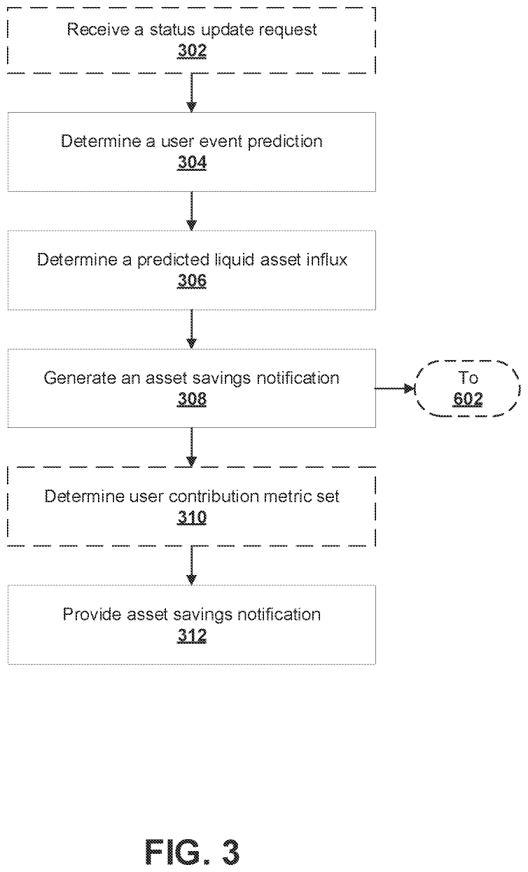

The predictive analysis system 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 3-7. As illustrated in FIG. 2, the apparatus 200 may include processor 202, memory 204, communications hardware 206, user evaluation circuitry 208, and organization analysis circuitry 210, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises a user evaluation circuitry 208 that may be configured to determine a user event prediction, determine a predicted liquid asset influx, and/or generate an asset savings notification. In some embodiments, the user evaluation circuitry 208 may further be configured to identify internal source data, identify an employer organization associated with a user, identify one or more other users associated with an employer organization, identify a similar user subset, and/or determine a user contribution metric set for a user. In some embodiments, the user evaluation circuitry 208 may be configured to additionally, or alternatively, identify an asset savings notification, determine a current resource metric set, and/or generate a resource allocation recommendation. In some embodiments, the user evaluation circuitry 208 may further be configured to determine one or more account metrics for each user account, identify internal source data, generate an account metric request, generate a forecast metric set, and/or generate supplemental information for the resource allocation recommendation. The user evaluation circuitry 208 may utilize processor 202, memory 204, or any other hardware component included in the apparatus 200 to perform these operations, as described in connection with FIGS. 3-7 below. The user evaluation circuitry 208 may further utilize communications hardware 206 to gather data from a variety of sources (e.g., third-party devices 108A through 108N or storage device 110, as shown in FIG. 1), and/or exchange data with a user, and in some embodiments may utilize processor 202 and/or memory 204.

In addition, the apparatus 200 further comprises an organization analysis circuitry 210 that is configured to determine one or more organization attributes associated with an employer organization. The organization analysis circuitry 210 may utilize processor 202, memory 204, or any other hardware component included in the apparatus 200 to perform these operations, as described in connection with FIGS. 3-7 below. The organization analysis circuitry 210 may further utilize communications hardware 206 to gather data from a variety of sources (e.g., third-party devices 108A through 108N or storage device 110, as shown in FIG. 1), and/or exchange data with a user, and in some embodiments may utilize processor 202 and/or memory 204.

Although components 202-210 are described in part using functional language, it will be understood that the particular implementations necessarily include the use of particular hardware. It should also be understood that certain of these components 202-210 may include similar or common hardware. For example, the user evaluation circuitry 208 and organization analysis circuitry 210 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry” and “engine” with respect to elements of the apparatus therefore shall be interpreted as necessarily including the particular hardware configured to perform the functions associated with the particular element being described. Of course, while the terms “circuitry” and “engine” should be understood broadly to include hardware, in some embodiments, the terms “circuitry” and “engine” may in addition refer to software instructions that configure the hardware components of the apparatus 200 to perform the various functions described herein.

Although the user evaluation circuitry 208 and organization analysis circuitry 210 may leverage processor 202, memory 204, or communications hardware 206 as described above, it will be understood that any of user evaluation circuitry 208 and organization analysis circuitry 210 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that user evaluation circuitry 208 and organization analysis circuitry 210 comprise particular machinery designed for performing the functions described herein in connection with such elements of apparatus 200.

In some embodiments, various components of the apparatus 200 may be hosted remotely (e.g., by one or more cloud servers) and thus need not physically reside on the corresponding apparatus 200. For instance, some components of the apparatus 200 may not be physically proximate to the other components of apparatus 200. Similarly, some or all of the functionality described herein may be provided by third party circuitry. For example, a given apparatus 200 may access one or more third party circuitries in place of local circuitries for performing certain functions.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Having described specific components of example apparatus 200, example embodiments are described below in connection with a series of graphical user interfaces and flowcharts.

### Example Operations

Turning to FIGS. 3-7, example flowcharts are illustrated that contain example operations implemented by example embodiments described herein. The operations illustrated in FIGS. 3-7 may, for example, be performed by system device of the predictive analysis system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, user evaluation circuitry 208, organization analysis circuitry 210, and/or any combination thereof. It will be understood that user interaction with the predictive analysis system 102 may occur directly via communications hardware 206, or may instead be facilitated by a separate device, which may have similar or equivalent physical componentry facilitating such user interaction.

### Example Operations for Determining an Asset Savings Notification

Turning first to FIG. 3, example operations are shown for generating and providing an asset savings notification. The asset savings notification may provide users with a notification advising them that they are the recipient of incoming funds before said funds are received in their account. In doing so, users may gain better insight into their finances and may be better able to plan how to best allocate these additional funds. In some embodiments, users may also be made aware of the user event prediction which is indicative of the reason for the predicted liquid asset influx such that user's may be immediately and better informed of why they are receiving these funds and/or where these funds are from. With this information, users may again be able to better plan both short-term and/or long-term goals. For example, if the user event prediction is indicative that the event is an annual bonus (e.g., an annual event), the user may be made aware the predicted liquid asset influx is a bonus and as such, may know this is conditional event and may not expect the same amount of predicted liquid asset influx in the following years or in a next paycheck. Alternatively, if the user event prediction is indicative that the event is a 401(k) cap limit is reached, the user may be made aware the predicted liquid asset influx is due to the elimination of funds being contributed to the user's 401(k) and instead staying in the user's paycheck. As such, the user may be made aware that this predicted liquid asset influx is to be expected until the end of year.

Optionally, as shown by operation 302, the apparatus 200 includes means, such as processor 202, memory 204, communications hardware 206, and/or the like, for receiving a status update request. In some embodiments, a status update request may be indicative of a request from a user regarding a status of his/her various accounts. The status of the one or more user accounts may be conveyed to the user by determining a user contribution metric set, as further described in operation 310. The user contribution metric set may be indicative of one or more user contribution metrics for one or more contribution fields over a particular time frame of interest.

In some embodiments, the status update request may also be indicative of a request for the apparatus 200 to determine whether a user event prediction is expected. As such, receipt of the status update request may trigger apparatus 200 to determine a user event prediction as described further in operation 304. In some embodiments, the status update request is received from a user, such as via any one of user devices 106A-106N. Alternatively, the status update request may be received from a user other than the user the request pertains to, such as an authorized user (e.g., an employee) that is associated with the predictive analysis system 102. The authorized user may provide the status update request on behalf of the user. The status update request may be indicative of a user identifier (e.g., a username, first name, last name, phone number, email address, account number, etc.) and optionally, one or more user credentials (e.g., a password, pin number, etc.) such that the apparatus 200 may determine the user to which the status update request pertains to.

As shown by operation 304, the apparatus 200 includes means, such as processor 202, memory 204, communications hardware 206, user evaluation circuitry 208 and/or the like, for determining a user event prediction. In some embodiments, the user evaluation circuitry 208 may be configured to perform an analysis of a user and/or associated user profile on a periodic or semi-periodic basis. Alternatively, the user evaluation circuitry 208 may be configured to perform an analysis of the user in response to receiving a request, such as a status update request. The user evaluation circuitry 208 may identify the user the status update request pertains using an included user identifier (e.g., a username, first name, last name, phone number, email address, account number, etc.) and may optionally authenticate the request using one or more provided user credentials (e.g., a password, pin number, etc.). In some embodiments, the request (e.g., a status update request) may include a time period of interest. Alternatively, the time period of interest may be automatically configured by an authorized user such that the user evaluation circuitry 208 may determine the time period of interest. The time period of interest may be indicative of a time period (e.g., within the next two weeks, months, six months, etc.) during which the user is interested in knowing whether one or more events are predicted to occur within.

A user event prediction may include an event and a corresponding event time frame within which the event is predicted to occur within. In some embodiments, the user evaluation circuitry 208 may determine a user event prediction only in an instance in which at least a portion of the event time frame is predicted to occur within the time period of interest. For example, a time period of interest may include a period of 2 months from the present date. As such, the user evaluation circuitry 208 may one or more determine user event predictions that are associated with an event time frame where at least a portion of the event time frame occurs within the time period of interest. By way of particular example, an event time frame may include a date range of Mar. 28, 2023, through Mar. 30, 2023. In an instance in which the current date is Jan. 28, 2023, the user evaluation circuitry 208 may determine the user event prediction because a portion of the event time frame occurs within the time period of interest.

The event described by the user event prediction may correspond to a contribution limit event, a temporally periodic event, or a circumstantial event. A contribution limit event may correspond to an event that occurs when a user is inferred to have reached a contribution limit for a particular contribution field. For example, if the user evaluation circuitry 208 determines that a user, who is under 50, has contributed $22,500 to a 401(k) contribution field, the user evaluation circuitry 208 may determine a contribution limit event and thus determine a user event prediction. The user event prediction may include an indication of the contribution limit event, and in particular, may detail that the contribution limit event is a 401(k) contribution limit event. Additionally, the event time frame may correspond to a predicted next pay period for the user. For example, if the user is paid on the 1^{st} and the 15^{th} of every month and it is currently the 1^{st} of the month, the user evaluation circuitry 208 may determine the event time frame is the 15^{th} of the month. This may convey to the user that the effects of the contribution limit event will occur on the 15^{th} of the month (e.g., in two weeks). Other contribution limit events may include an HSA contribution limit event, a social security contribution limit event, an FSA contribution limit event, a 529 plan contribution limit event, an investment contribution limit, and/or the like.

A contribution field may correspond to a particular user account type that may be associated with particular limits, rules, and/or regulations. For example, a contribution field may be a 401(k) contribution field which may be associated with a maximum annual contribution limit of $22,500 for those younger than 50 years old and a maximum annual contribution $30,000 for those 50 years old and older. Another contribution field may be a health savings account (HSA) contribution field which may be associated with a maximum annual contribution limit of $4,150 for an individual, a maximum annual contribution limit of $8,300 for a family, and additional have a rule set that allows users 55 years old and older to contribute an additional $1000. As yet another example, a contribution field may be a 529 plan contribution field which may not have a maximum annual contribution limit. However, the 529 plan contribution field instead be associated with a maximum of $17.000 per individual or a maximum of $85,000 over a five-year period that is not associated with a gift tax but may allow for contributions over these amounts (e.g., which are then subject to the gift-tax). Other contribution fields may include a flexible spending account (FSA) contribution field, an individual retirement account (IRA) contribution field, a social security contribution field, a savings account contribution field, an investment contribution field (e.g., stocks, bonds, mutual funds, cryptocurrency, etc.), a checking contribution field, and/or the like. In some embodiments, contribution fields may additionally include accounts which are associated with user liabilities, such as a credit card contribution field, a loan contribution field (e.g., a student loan contribution field, a mortgage contribution field, an auto contribution field, etc.), and/or the like.

In some embodiments, a user contribution metric may be indicative of an amount the user has contributed to a particular contribution field and may further be indicative of contribution limits if applicable. For example, a user who has contributed $18,000 to a 401(k) contribution field may be associated with user contribution metrics of $18,000 annual contribution to-date and 80% annual contribution to-date, indicating that the user has contributed $18,000 to his/her 401(k) and has contributed 80% of the contribution limit. Additionally, the user may have a total of $100,000 saved in his/her 401(k) account and thus a user contribution metric may include $100,000 total, indicating that the user has a total of $100,000 in his/her 401(k) account.

In some embodiments, a contribution field may be associated with one or more user accounts. For example, a user may have three 401(k) accounts. As such, certain user contribution metrics may take into account all accounts associated with a certain contribution field while other user contribution metrics may be considered individually for each account. For example, a user who has contributed $10,000 to a first 401(k) account and $8,000 to a second 401(k) account, and $0 to a third 401(k) account may be associated with user contribution metrics of $18,000 annual contribution to-date and 80% annual contribution to-date, indicating that the user has contributed $18,000 across his/her 401(k) accounts and has contributed 80% of the contribution limit. Additionally, the user may have a total of $100,000 saved across his/her 401(k) accounts and thus a user contribution metric may include $100,000 aggregate total, indicating that the user has a total of $100,000 across all his/her 401(k) accounts. Furthermore, a user contribution metric may include a $10,000 annual contribution and a $25,000 total for the first 401(k) account and $8,000 annual contribution and a $25,000 total for the second 401(k) account, and a $0 annual contribution and a $50,000 total for the third 401(k) account. As such, the user may be made aware of a status across all accounts of a certain contribution field as well a status of individual accounts.

A temporally periodic event may correspond to an event that occurs periodically or semi-periodically for the user. For example, a temporally periodic event may correspond to an annual bonus, an income tax refund check, dividends, and/or the like. A temporally periodic event may be associated with events that occur at particular and regular time periods within the year. As such, temporally periodic events may be recurrent and/or predictable in nature. For example, the user evaluation circuitry 208 may analyze internal source data pertaining to the user (as described in greater detail below) and determine the user receives an annual bonus on January 15^{th}. Thus, the event time frame may correspond to a predicted next bonus for the user. This may convey to the user that the effects of the temporally periodic event will occur on a particular date (e.g., January 15^{th}).

A circumstantial event may include irregular or one-time events that are caused by a particular set of circumstances. For example, a circumstantial event may correspond to a relocation bonus, a sign-on bonus, unscheduled or special dividends, sales commissions, and/or the like. In some embodiments, the user evaluation circuitry 208 may use additional data sources or additional processing operations to identify circumstantial events for a user due to their irregularity.

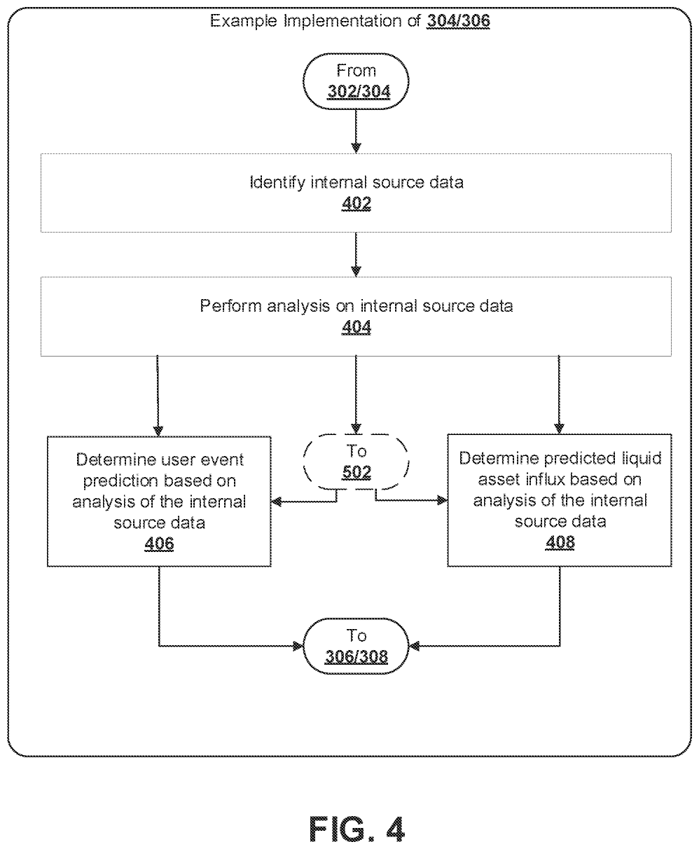

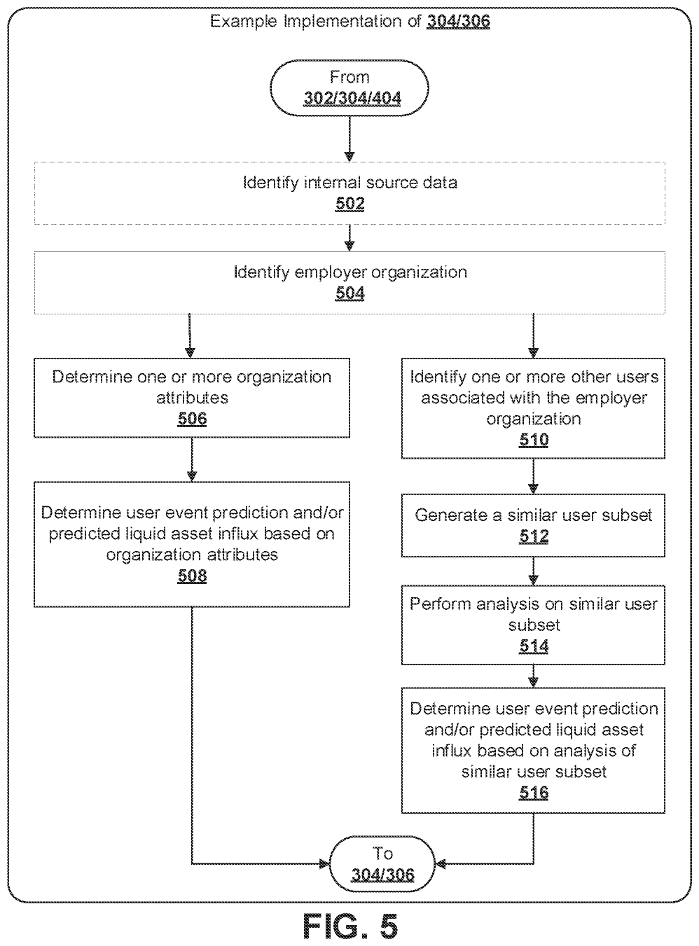

In some embodiments, the user evaluation circuitry 208 may perform an analysis of the user using internal source data as further described in FIG. 4, to determine the user event prediction. In some embodiments, the internal source data includes income data sourced from one or more of direct deposit documents, paycheck documents, or self-reported income for the user. Additionally, or alternatively, the user evaluation circuitry 208 may identify an employer organization for the user based on the internal source data as described in further detail in FIG. 5 and may determine the user event prediction based on the employer organization. In some embodiments, one or more organization attributes may then be determined for the employer organization and the one or more organization attributes may be used to determine the user event prediction. In some embodiments, once the employer organization is identified, the user evaluation circuitry 208 may identify one or more other users associated with the employer organization, identify a similar user subset from the one or more other users, and perform an analysis on the similar user subset. The user evaluation circuitry 208 may then determine the user event prediction based on the analysis of the similar user subset.

As described above, the user evaluation circuitry 208 may use various data pertaining to the user to determine the user event prediction. As such, the user evaluation circuitry 208 may determine the user event prediction for the user based on the individual history of the user, the history of the user's employer organization, and/or a history of user's determined to be similar to the user and who also are associated with the employer organization. Thus, the user evaluation circuitry 208 may determine an event time frame for the user event prediction with increased accuracy.

In some embodiments, the user evaluation circuitry 208 may use an event prediction model to determine the user event prediction for the user. The event prediction model may be a rules-based model or a machine learning model (e.g., a neural network) that is configured to determine the user event prediction based on provided input data. The input to the event prediction model may be variable based on the availability of the data and as such, in some embodiments the event prediction model may be a flexible model that is configured to make predictions (e.g., determine a user event prediction) based on a wide range of data inputs. Input to the event prediction model may include internal source data pertaining to the user, one or more organization attributes pertaining to the employer organization associated with the user, and/or a similar user subset that includes user identifiers and/or anonymized user data of users who are associated with the employer organization and are determined to be similar to the user. In some embodiments, the event prediction model may be configured to pre-process the input data using one or more suitable techniques, such as optical character recognition (OCR), intelligent character recognition (ICR), natural language processing (NLP) techniques, and/or the like.

In some embodiments, the event prediction model use statistical modeling and/or syntactic modeling to determine the user event prediction based on inferred likelihoods of an event based on analysis of the input data. In some embodiments, the event prediction model may be a neural network, such as a convolutional neural network (CNN) or long-short term memory (LSTM), that is configured to process the input data and identify patterns within the input data that can be used to predict and determine an event as well as the event time frame. The event prediction model may output the event and the event time frame to the user evaluation circuitry 208 which may then determine the user event prediction for the user.

As shown by operation 306, the apparatus 200 includes means, such as processor 202, memory 204, communications hardware 206, user evaluation circuitry 208 and/or the like, for determining a predicted liquid asset influx. In some embodiments, the user evaluation circuitry 208 may determine a predicted liquid asset influx in response to determining the user event prediction. The predicted liquid asset influx may be indicative of a value or value range of funds that correspond to the event described by the user event prediction. The predicted liquid asset influx may therefore be indicative of a predicted amount of funds that the user is predicted to receive during the event time frame.

In some embodiments, the user evaluation circuitry 208 may determine the predicted liquid asset influx based on the user event prediction. For example, the user evaluation circuitry 208 may determine the predicted liquid asset influx based on the type of event (e.g., contribution limit event, a temporally periodic event, or a circumstantial event) included in the user event predicted. By way of particular example, a contribution limit event, such as a 401(k) limit contribution event, may indicate to the user evaluation circuitry 208 that the predicted liquid asset influx may be determined based on a regular user contribution amount to a 401(k) account. Thus, the user evaluation circuitry 208 may determine the predicted asset influx based on an analysis of internal source data pertaining to the user, which may include a paycheck document that is indicative of a periodic contribution amount from the user and/or a from an associated employer organization. As another example, a temporally periodic event, such as an annual bonus event, may indicate to the user evaluation circuitry 208 that the predicted liquid asset influx may be determined based on an analysis of internal source data pertaining to the user, such as past bonuses the user has received from an employer organization that have within a threshold range of the dates described by the event time frame. Additionally, or alternatively, the user evaluation circuitry 208 may further determine the predicted liquid asset influx based on one or more organization attributes and/or an analysis of previous bonuses received by users in a similar user subset, which may have the same or a similar role as the user within an employer organization.

In some embodiments, the predicted liquid asset influx may be predicted simultaneously with the user event prediction. For example, the user evaluation circuitry 208 may use the event prediction model to simultaneously determine the user event prediction and the predicted liquid asset influx using the same inputs. In other embodiments, the predicted liquid asset influx and the user event prediction may be determined individually. For example, the user evaluation circuitry 208 may use the event prediction model to first determine the user event prediction using a first set of inputs and use an event prediction model (e.g., either the same event prediction model or a different event prediction model) to determine the predicted liquid asset influx using a second set of inputs that may be different from the first set of inputs.

The user evaluation circuitry 208 may use various data pertaining to the user to determine the liquid asset influx. Similar to operation 304, in some embodiments, the user evaluation circuitry 208 may perform an analysis of the user using internal source data as further described in FIG. 4, to determine the predicted liquid asset influx. In some embodiments, the internal source data includes income data sourced from one or more of direct deposit documents, paycheck documents, or self-reported income for the user. Additionally, or alternatively, the user evaluation circuitry 208 may identify an employer organization for the user based on the internal source data as described in further detail in FIG. 5, to determine the predicted liquid asset influx. One or more organization attributes may then be determined for the employer organization and the one or more organization attributes may be used to determine the predicted liquid asset influx. In some embodiments, once the employer organization is identified, the user evaluation circuitry 208 may identify one or more other users associated with the employer organization, identify a similar user subset from the one or more other users, and perform an analysis on the similar user subset. The user evaluation circuitry 208 may then determine the predicted liquid asset influx based on the analysis of the similar user subset.

In some embodiments, either operation 304 and/or 306 may be performed in accordance with the operations described by FIG. 4. Turning now to FIG. 4, example operations are shown for performing an analysis of internal source data to determine a user event prediction and/or determine a predicted liquid asset influx. By leveraging internal source data, the user evaluation circuitry 208 may determine an individual history of the user and optionally, may identify an employer organization for the user such that additional analyses may be performed, as described in greater detail in FIG. 5. As described above, in some embodiments, the user evaluation circuitry 208 may be configured to simultaneously determine the user event prediction and predicted liquid asset influx or may be configured to determine the user event prediction and predicted liquid asset influx separately.

As shown by operation 402, the apparatus 200 includes means, such as processor 202, memory 204, communications hardware 206, user evaluation circuitry 208 and/or the like, for identifying internal source data. As described above, internal source data may include income data sourced from one or more of direct deposit documents, paycheck documents, or self-reported income for user. In some examples, internal source data may also be indicative of one or more accounts and/or one or more user account attributes associated with the user, such as one or more checking accounts, savings accounts, investment accounts, credit card accounts, loan accounts, and/or the like. A user account attribute may include an account log indicating changes to the account (e.g., opened, closed, withdrawals, deposits, transfers, etc.), an account balance, account details (e.g., account number, account age, users associated with the account, etc.), a user account type (e.g., a checking user account type, a savings user account type, an investment user account type, a 401(k) user account type, a credit card user account type, a loan user account type, FSA user account type, HSA user account type IRA user account type and/or the like), etc.

The user evaluation circuitry 208 may be configured to identify internal source data based on an associated user profile that may one or more user accounts, such as financial accounts, and may also include the internal source data. Internal source data may be received from the user via one or more of the one or more user devices (e.g., any one of user devices 106A-106N), a user other than the user to which the user event prediction pertain to via one or more of the one or more user devices (e.g., any one of user devices 106A-106N), a third-party provider such as an employer organization, an investment entity, a credit agency, the IRS, and/or the like via one or more of third-party devices (e.g., any one of third-party devices 108A-108N). For example, an employer organization (e.g., a third-party entity) may pay the user via direct deposit which causes an associated user account to receive the funds from the employer organization and the digital paycheck may be stored in the user account as internal source data. As another example, an investment entity (e.g., a third-party entity) may provide a dividend payment from a third-party account of the user to a user account that is associated with the predictive analysis system 102. The third-party entity may also provide a dividend statement, which may be stored as internal source data in the associated user account. Additionally, the direct deposit and dividend payment may be logged in a history of the particular user account they were deposited into. The internal source data may be associated with a particular timestamp, indicative of the time and/or date the particular data was received and/or stored in the user profile.

In some embodiments, the user evaluation circuitry 208 may only identify internal source data that corresponds to a particular data source time period of interest. A data source time period of interest may be a configured parameter that may be set by an authorized user that indicates which data the user evaluation circuitry 208 should utilize for the user. For example, a data source time period of interest may be three years such that only internal source data that occurred within the last three years is identified by the user evaluation circuitry 208. Thus, the user evaluation circuitry 208 may consider up-to-date internal source data while still capturing long-term patterns for the user.

As shown by operation 404, the apparatus 200 includes means, such as processor 202, memory 204, communications hardware 206, user evaluation circuitry 208 and/or the like, for performing an analysis on the internal source data. In some embodiments, the user evaluation circuitry 208 may perform the analysis of the internal source data using the event prediction model as described above in operations 304 and 306. In particular, internal source data may be provided to the event prediction model and the event prediction model may be configured to (i) determine the user event prediction based on the internal source data, (ii) determine the predicted liquid asset influx based on the internal source data, and/or (iii) identify an employer organization based on the internal source data and perform additional operations as described in greater detail in FIG. 5.

In some embodiments, the event prediction model may be configured to pre-process the internal source data (e.g., input data) using one or more suitable techniques, such as OCR, ICR, NLP techniques, and/or the like. For example, internal source data may include a paystub that is associated with a corresponding direct deposit. The event prediction model may analyze a most recent paystub to identify a current 401(k) contribution value for the current pay period and, in some embodiments, a total 401(k) contribution value (if available) on the paystub. If the total 401(k) contribution value is not indicated on the paystub, the event prediction model may additionally analyze paystubs in the internal source data that have been received from January 1^{st} up to the current date. As such, the event prediction model may determine an up-to-date total user contribution metric for a 401(k) contribution field for the user. In some embodiments, the event model may update a user contribution metric set based on the analysis of the internal source data. As another example, the event prediction model may analyze paystub data over the past year and determine that the user typically receives a separate deposit from the employer organization on a particular date.

The event prediction model may further determine whether the analysis of the internal source data is indicative of a particular event for the user. For example, the event prediction model may use the updated user contribution metric set to determine whether one or more limits have been reached by the user for a particular contribution field. By way of continuing example, the event prediction model may determine a total user contribution metric for a 401(k) contribution field is associated with a value of $22,500 such that the event prediction model may determine the user has contributed a maximum amount to the particular contribution field. As such, the event prediction model may determine that the event is a contribution limit event. Additionally, the event prediction model may determine an event time frame that corresponds to the user's next paycheck. For example, if the user is paid on the second Friday and last Friday of each month and currently the date falls on a day in the third week of the month, the event prediction model may determine an event time frame of the last Friday of the month.

In some embodiments, the event prediction model may determine whether the analysis of the internal source data is indicative of a historical event for the user that has occurred within a similar time frame of interest. For example, the event prediction model may process the internal source data and determine that a user has received a bonus on the last day of January for the past two years. As such, the event prediction model may determine a temporally periodic event for the user that corresponds to a bonus event in the instance in which the time period of interest includes the last day of January. Additionally, the event prediction model may determine an event time frame of the last day of January for the event based on this internal source data.

The event prediction model may also use historical event data to determine a predicted liquid asset influx for the event. By way of continuing example, the event prediction model may determine a bonus amount for the historical bonuses the user has received and determine the predicted liquid asset influx for the temporally periodic event (e.g., due to a predicted bonus) based on the historical amount of the user's received bonuses. As such, the event prediction model may leverage existing and historical data of the user to improve the accuracy of the user event prediction and the predicted liquid asset influx.

Optionally, as shown by operation 406, the apparatus 200 includes means, such as processor 202, memory 204, communications hardware 206, user evaluation circuitry 208 and/or the like, for determining the user event prediction based on the analysis of the internal source data. As described above, the internal source data may be analyzed and used to determine the user event prediction. In particular, the event prediction model may be used to determine an event type (e.g., a contribution limit event, a temporally periodic event, or a circumstantial event) as well as an event time frame for the event.

Optionally, as shown by operation 408, the apparatus 200 includes means, such as processor 202, memory 204, communications hardware 206, user evaluation circuitry 208 and/or the like, for determining the predicted liquid asset influx based on the analysis of the internal source data. As described above, the internal source data may be analyzed and used to determine the predicted liquid asset influx. In particular, the event prediction model may be used to determine the predicted liquid asset influx.

Additionally, or alternatively, in some embodiments, either operation 304 and/or 306 may be performed in accordance with the operations described by FIG. 5. Turning now to FIG. 5, example operations are shown for identifying an employer organization of the user and determining the user event prediction and/or the predicted liquid asset influx based on the employer organization.

Optionally, as shown by operation 502, the apparatus 200 includes means, such as processor 202, memory 204, communications hardware 206, user evaluation circuitry 208 and/or the like, for identifying internal source data. In some embodiments, the user evaluation circuitry 208 may be configured to identify internal source data similarly as described in operation 402. In some embodiments, the user evaluation circuitry 208 may proceed from operation 404 of FIG. 4 to operation 504 of FIG. 5 such that the user evaluation circuitry 208 may already have identified the internal source data (e.g., in operation 402) and as such, may not need to perform operation 502.

As shown by operation 504, the apparatus 200 includes means, such as processor 202, memory 204, communications hardware 206, user evaluation circuitry 208 and/or the like, for identifying an employer organization. The user evaluation circuitry 208 may analyze the internal source data to identify the employer organization. In some embodiments, the user may provide his/her employer organization to the user evaluation circuitry 208. As described above, the user evaluation circuitry may use an event prediction model to identify an employer organization using the internal source data.

As described above, in some embodiments, the user may provide his/her employer organization to the user evaluation circuitry 208. For example, a user or an authorized user (e.g., an administrator or employee associated with the system operating apparatus 200) may update an employer data field in a user profile. This change may be associated with a timestamp indicative of the date and/or time the employer data field was updated. In an instance in which the timestamp satisfies one or more timestamp thresholds (e.g., within the past two weeks), the user evaluation circuitry 208 may be configured to identify the employer organization from the employer data field of the user profile. In an instance in which the timestamp fails to satisfy one or more timestamp thresholds, the user evaluation circuitry 208 may be configured to perform an analysis of the internal source data to identify the employer organization.

In particular, the user evaluation circuitry 208 may use the event prediction model to analyze the internal source data and identify the employer organization. In particular, the event prediction model may use techniques such as OCR, ICR, NLP to process the internal source data and identify an employer organization. In some embodiments, the event prediction model may be configured to identify particular keywords to identify the employer organization. In some embodiments, the employer organization is determined based on the context within the internal source data. For example, internal source data may be a credit application and include the text “employer” and text “ABC Corp” directly adjacent to the “employer” text. As such, the one or more processing models may identify the employer organization to be “ABC Corp” based on the “employer” context in the internal source data. As another example, internal source data may be a direct deposit document and include the text “ABC Corp” as well as a text indicating the routing number and account number of the payroll account used to fund the direct deposit. As such, the one or more processing models may identify the organizational entity as “ABC Corp” based on the text “ABC Corp” and/or the routing number and account number. In some embodiments, if the routing number is associated with a network associated with apparatus 200, the user evaluation circuitry 208 may perform a lookup of the employer organization associated with the account number to identify the organizational entity.

In some embodiments, the event prediction model may be configured to use the most recent internal source data for the user to identify the employer organization. For example, the event prediction model may be configured to use a most recent paystub included in the internal source data to identify the employer organization for the user. As such, the identified employer organization for the user may be up-to-date and accurate, such as in a scenario in which a user has recently changed employers. Once the event prediction model has identified the employer organization for the user, the user evaluation circuitry 208 may update and/or store the employer organization in a corresponding user profile of the user. As such, the user may be associated with an up-to-date and accurate current employer organization by way of his/her user profile.

In some embodiments, an employer organization identifier may be stored in the user profile such that the employer organization is standardized and/or homogenized between user profiles. The user evaluation circuitry 208 may determine the employer organization identifier based on the information from the internal source data and/or information provided by the user. For example, the event prediction model may process a deposit document that includes the text “ABC Corp” and identify that the employer organization is “ABC Corp”. The user evaluation circuitry 208 may then perform a look-up operation or other operation within an employer organization database to identify a corresponding employer organization identifier of ABCCorp123 that is associated “ABC Corp”. The employer organization database may employer organization identifiers and corresponding common representations of the employer organization. For example, the employer organization identifier ABCCorp123 may be associated with representations of “ABC Corp”, “ABC Corporation”, “ABC Corp.”, “ABC”, “123456″89” which may be a routing number of ABC Corp, and/or the like. The user evaluation circuitry 208 may determine whether the employer organization (e.g., as determined by the internal source data and/or as provided by the user) corresponds to a representation and then identify the employer organization identifier based on the representation determined to correspond to (e.g., match) the identified employer organization.

Optionally, as shown by operation 506, the apparatus 200 includes means, such as processor 202, memory 204, communications hardware 206, organization analysis circuitry 210 and/or the like, for determining one or more organization attributes. Once the employer organization has been identified, the organization analysis circuitry 210 may be configured to determine one or more organization attributes for the employer organization. An organization attribute may indicate one or more attributes or parameters that apply to the employer organization. For example, the one or more organization attributes may include a bonus cadence (e.g., annual, quarterly, no bonus, etc.), a bonus position eligibility indicative of which positions or titles within the employer organization are eligible for and/or receive a bonus, a bonus range indicative of a fund range given out by bonuses, a bonus range by position indicative of a fund range given out by bonuses based on a position within the employer organization, a contribution field match (e.g., a 401(k) match, etc.), and/or the like. In some embodiments, the one or more organization attributes may be stored in a storage repository (e.g., memory 204, storage device 110, or an external storage) such that the organization analysis circuitry 210 may be configured to access the storage repository to determine the one or more organization attributes. In some embodiments, the one or more organization attributes may be organized based on an employer organization identifier, such as an employer organization name or unique number, such that that organization analysis circuitry 210 may query the storage repository for the employer organization identifier to determine the one or more organization attributes.

As shown by operation 508, the apparatus 200 includes means, such as processor 202, memory 204, communications hardware 206, user evaluation circuitry 208 and/or the like, for determining the user event prediction and/or predicted liquid asset influx based on the one or more organization attributes. Once the organization analysis circuitry 210 has determined the one or more organization attributes, the user evaluation circuitry 208 may determine the user event prediction and/or predicted liquid asset influx based on the one or more organization attributes. In particular and as described above, the user evaluation circuitry 208 may provide the one or more organization attributes to the event prediction model. The event prediction model may then be configured to process the one or more organization attributes to determine the user event prediction and/or predicted liquid asset influx. In particular, the one or more organization attributes may provide employer organization specific information to the event prediction model such that the event prediction model may increase the accuracy of the user event prediction and/or predicted liquid asset influx.

As described above, the one or more organization attributes may be indicative of attributes or parameters that apply to the employer organization and may provide an indication of an event time frame and/or a liquid asset influx. For example, the one or more organization attributes may indicate a timing for a temporally periodic event, such as a bonus cadence. Thus, the organization attributes may provide information that may be used by the event prediction model to determine a user event prediction. As another example, the one or more organization attributes may indicate a bonus range by position indicative of a fund range given out by bonuses based on a position within the employer organization. Thus, the organization attributes may provide information that may be used by the event prediction model to determine a predicted liquid asset influx. In some embodiments, the event prediction model may use the one or more organization attributes along with an analysis of the internal source data and/or an analysis of a similar user subset to accurately determine the user event prediction and/or predicted liquid asset influx.

Additionally, or alternatively, as shown by operation 510, the apparatus 200 includes means, such as processor 202, memory 204, communications hardware 206, user evaluation circuitry 208 and/or the like, for identifying one or more other users associated with the employer organization. In some embodiments, the user evaluation circuitry 208 may identify one or more other users who are also associated with the employer organization. For example, the one or more other users may also be employees of the employer organization. In some embodiments, a user may be associated with the employer organization via an employer field that is associated with a corresponding user profile. As such, the user evaluation circuitry 208 may identify the one or more other users whose employer field in his/her corresponding user profile is also associated with the same employer organization matching the user's. In particular, the user evaluation circuitry 208 may use the employer organization identifier to identify the one or more other users as the employer organization identifier is standardized amongst user profiles.

As shown by operation 512, the apparatus 200 includes means, such as processor 202, memory 204, communications hardware 206, user evaluation circuitry 208 and/or the like, for generating a similar user subset. Once the user evaluation circuitry 208 has determine the one or more other users associated with the employer organization, the user evaluation circuitry 208 may identify a similar user subset. The similar user subset may include one or more users determined to share at least one common attribute with the user. The user evaluation circuitry 208 may determine one or more user attributes for the user and the one or more other users based on the corresponding user's user profile. The one or more user attributes may include an employment title or position, an employment department, educational information (e.g., degrees, majors, certifications, etc.), an associated salary, a geographic location, and/or the like. The user evaluation circuitry 208 may then identify one or more users from the one or more other users who share at least one user attribute with the user of interest and list these users in the similar user subset. As such, the similar user subset may narrow down the number of users from all users within an employer organization to only users who are determined to be similar to the user of interest, thereby reducing associated computational processing requirements while maintaining prediction accuracy.

As shown by operation 514, the apparatus 200 includes means, such as processor 202, memory 204, communications hardware 206, user evaluation circuitry 208 and/or the like, for performing an analysis on the similar user subset. Once the user evaluation circuitry 208 has generated the similar user subset, the user evaluation circuitry 208 may perform an analysis on the similar user subset. In particular, the user evaluation circuitry 208 may use the event prediction model to process the similar user subset. The event prediction model may then be configured to process the similar user subset to determine the user event prediction and/or predicted liquid asset influx. In particular, the event prediction model may perform an analysis on each user profile, including associated internal source data, for each user included in the similar user subset. The analysis of the user profiles may be similar to the analysis of the user profile described in operation 404 of FIG. 4. The analysis of the user profiles for users included in the similar user subset may provide additional data points that the event prediction model may use to determine an event prediction and/or predicted liquid asset influx. In particular, an analysis of the user profile for users included in the similar user subset may allow the event prediction model to identify common events, such as bonuses, and may further allow the event prediction model to identify a predicted liquid asset influx for each event, such as bonus amount.

As shown by operation 516, the apparatus 200 includes means, such as processor 202, memory 204, communications hardware 206, user evaluation circuitry 208 and/or the like, for determining the user event prediction and/or predicted liquid asset influx based on the analysis of the similar user subset. Once the user evaluation circuitry 208 has performed the analysis of user profiles for users included in the similar user subset via the event prediction model, the user evaluation circuitry 208 may determine the event prediction and/or predicted liquid asset influx. In some embodiments, the event prediction model may perform a similarity analysis between the user and each user included in the similar user subset. For example, the event prediction model may be configured to cluster the user and the users included in the similar user subset based on their associated user attributes and determine a similarity score for the user and each user included in the similar user subset based on the Euclidean distance between the corresponding data points. The event prediction model may alternatively use other similarity comparison metrics. The similarity score for the user and the one or more other users included in the similarity user subset may provide an indication of analysis of user profile of users within the similar user subset are most applicable such that the analysis of these user profile may be weighted more heavily when determining the user event prediction and/or predicted user subset.

As described above, the analysis of a user profile for a user included in the similar user subset may be indicative of event time frame and/or a liquid asset influx that may also apply to the user. This may be particularly useful in scenarios in which the user has recently been employed by an employer organization and thus, may not have much data associated with the employment organization. For example, user profiles for users with similar employment titles to the user may analyzed to reveal a timing for a temporally periodic event, such as a bonus cadence, as well as a predicted liquid asset influx, such as a bonus range. Thus, the analysis of the similar user subset may provide information that may be used by the event prediction model to determine a user event prediction and/or predicted liquid asset influx. In some embodiments, the event prediction model may use the analysis of the similar user subset along with the analysis of the internal source data and/or one or more organization attributes to accurately determine the user event prediction and/or predicted liquid asset influx, as described above.

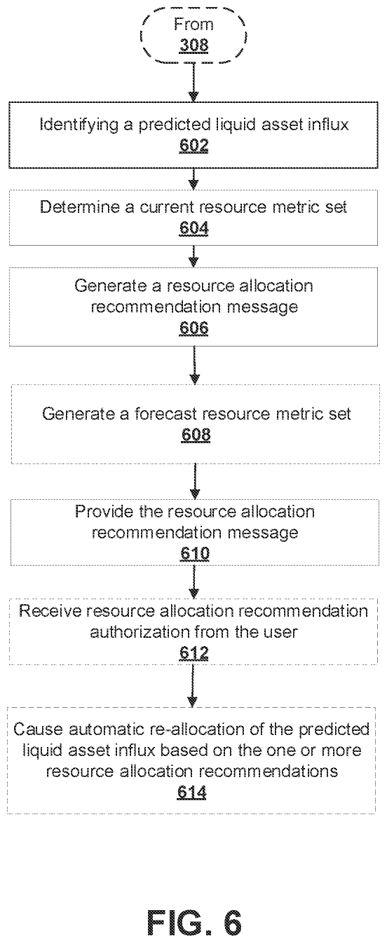

Returning now to FIG. 3, as shown by operation 308, the apparatus 200 includes means, such as processor 202, memory 204, communications hardware 206, user evaluation circuitry 208 and/or the like, for generating an asset savings notification. Once the user evaluation circuitry 208 has determined the user event prediction and/or predicted liquid asset influx, the user evaluation circuitry may generate the asset savings notification. The asset savings notification may include an indication of the predicted liquid asset influx and the event time frame. As such, the asset savings notification may convey information of the occurrence of a predicted event, the event time frame of the predicted event, and a result of the predicted event (e.g., a predicted liquid asset influx). Users may use the asset savings notification to improve their awareness of their financial accounts and further, determine funds which are safe to save. Said otherwise, these safe to save funds may differ from funds that the user typically receives and as such, may be unaware of. Users may then be afforded the option to treat these funds differently than other funds they receive, such as by re-allocating these funds to particular account as will be described in further detail in FIG. 6.

Optionally, as shown by operation 310, the apparatus 200 includes means, such as processor 202, memory 204, communications hardware 206, user evaluation circuitry 208 and/or the like, for determining a user contribution metric set. In some embodiments, a user contribution metric set may include one or more user contribution metrics for one or more contribution fields. For example, a contribution field may be a 401(k) contribution field and a user contribution metric may be indicative of a total contribution amount to date. As another example, a contribution field may be a savings contribution field and a user contribution metric may be indicative of a total savings amount. In some embodiments, the user contribution metric set may be included in the asset savings notification. As such, a user may be made aware of his/her current contributions and optionally, his/her contributions in total. This provided contribution context may aid the user in determining how to best allocate his/her predicted liquid asset influx.

Finally, as shown by operation 312, the apparatus 200 includes means, such as processor 202, memory 204, communications hardware 206, and/or the like, for providing the asset savings notification. Once the user evaluation circuitry 208 has generated the asset savings notification, the communications hardware 206 may provide the asset savings notification to the user, such as via a corresponding user device (e.g., any one or user devices 106A-106N). The asset savings notification may further be formatted in any suitable communication format, such as via email, SMS text, via an associated application, etc. In some embodiments, the asset savings notification may be stored in a user profile associated with the user. In some embodiments, in an instance in which a user logs an associated user account, such as via a user device, the asset savings notification may be displayed to him/her via within his/her user account.

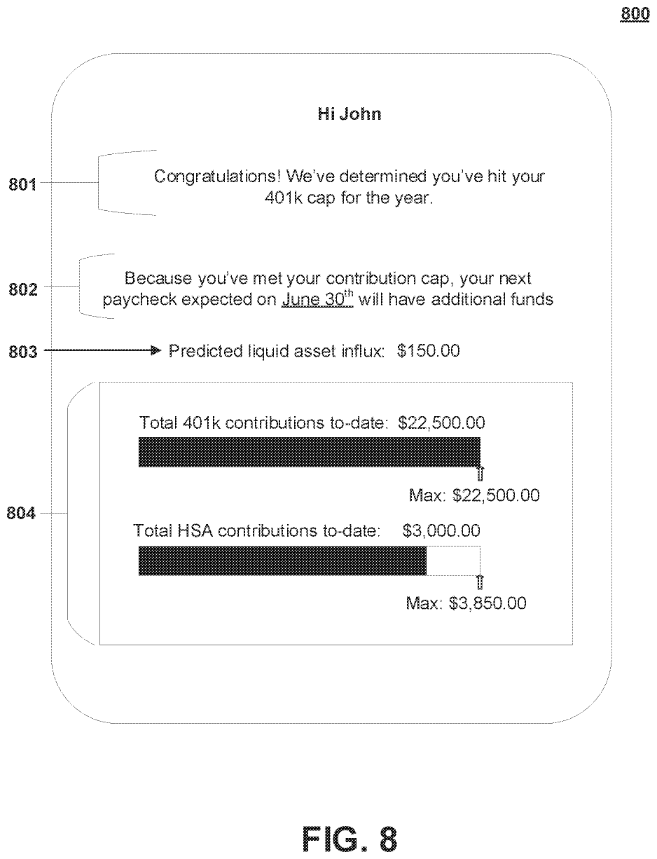

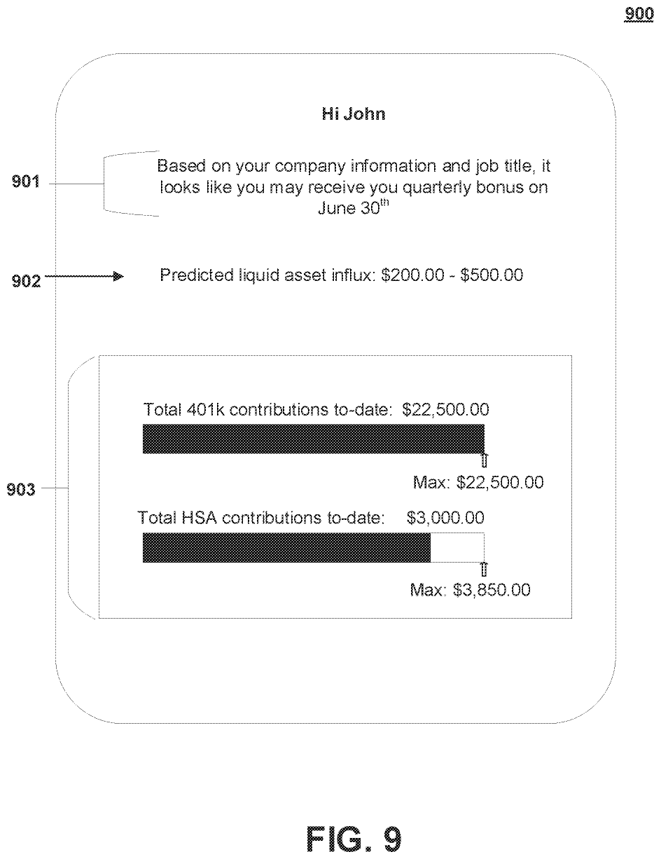

Turning to FIGS. 8-9, a graphical user interface (GUI) is provided that illustrates example asset savings notifications. As noted previously, a user may interact with the predictive analysis system 102 by directly engaging with communications hardware 206 of an apparatus 200. In such an embodiment, the GUI shown in FIGS. 8 and 9 may be displayed to a user by the apparatus 200. Alternatively, a user may interact with the predictive analysis system 102 using a separate user device (e.g., any of user devices 106A through 106N, as shown in FIG. 1), which may communicate with the predictive analysis system 102 via communications network 104. In such an embodiment, the GUI shown in FIG. 8 and FIG. 9 may be displayed to the user by the corresponding user device.

As shown by FIG. 8, the asset savings notification 800 may provide the user with an indication of the event 801 and an event time frame 802. Additionally, the asset savings notification 800 may indicate a predicted liquid asset influx 803 as well as a user contribution metric set 804 for one or more contribution fields. As such, the user may view the asset savings notification 800 and be made aware of an upcoming predicted event, a type of event (e.g., a contribution limit event), and a result of the predicted event (e.g., receiving $150.00). Thus, the user may determine this amount is safe to save from their next paycheck.

As another example, FIG. 9 shows another example of an asset savings notification 900. The asset savings notification 900 may similarly provide the user with an indication of the event and an event time frame 901. Additionally, the asset savings notification 900 may indicate a predicted liquid asset influx 902 as well as a user contribution metric set 903 for one or more contribution fields. The user may view the asset savings notification 900 and be made aware of an upcoming predicted event, a type of event (e.g., a temporally periodic event), and a result of the predicted event (e.g., receiving between $200.00-$500.00). Thus, the user may determine this amount is safe to save from their next paycheck.

### Example Operations for Determining a Resource Allocation Recommendation

Turning now to FIG. 6, example operations are shown for generating and providing resource allocation recommendation. The operations described by FIG. 6 may be performed in addition to the operations described in FIGS. 3-5 or may be performed separately. A resource allocation recommendation may provide users with insights into their various accounts such that they may decide on how best to allocate a predicted liquid asset influx to best serve his/her needs, thus saving the user time and resources. Additionally, in some embodiments, users made be provided with a resource allocation recommendation before any funds are received into their account. As such, users may take immediate action, such as routing a portion of the funds to a particular account. In some embodiments, apparatus 200 may automatically perform this fund routing on behalf of the user. For example, a user may be unaware that he/she is going to receive additional funds (e.g., due to an event described by the user event prediction) and/or may not know what to do with these additional funds. As such, conventionally, these funds may be deposited into a user account (e.g., a default user account) and may go unnoticed by a user. However, it may be beneficial for the user to re-allocate these funds to different accounts as soon as possible in order to reap the most benefit. For example, a user may receive a predicted liquid asset influx due to receiving a bonus at work. Rather than depositing the bonus into a user's typical financial account, the apparatus 200 may determine that the user has a high-interest car loan and therefore, a user may benefit from allocating at least a portion of the predicted liquid asset influx to paying off the principal of the high-interest car loan.

As shown by operation 602, the apparatus 200 includes means, such as processor 202, memory 204, communications hardware 206, and/or the like, for receiving identifying a predicted liquid asset influx. In some embodiments, the apparatus 200 may identify the predicted liquid asset influx from an associated asset savings notification as generated at operation 308 or may identify the liquid asset influx as generated at operation 306. Alternatively, the associated asset savings notification and/or liquid asset influx may be stored in a user profile that is stored an associated memory (e.g., in storage device 110, memory 204, or another storage device) such that the apparatus 200 may identify the predicted liquid asset influx from analysis of a user profile. As described above, the predicted liquid asset influx may be indicative of a value or value range of funds that are predicted to be received by a user in response to an event. The predicted liquid asset influx may therefore be indicative of a predicted amount of funds that the user is predicted to receive during a particular event time frame.

As shown by operation 604, the apparatus 200 includes means, such as processor 202, memory 204, communications hardware 206, user evaluation circuitry 208 and/or the like, for determining a current resource metric set. Once apparatus 200 has identified the predicted liquid asset influx, the user evaluation circuitry 208 may determine a current resource metric set for the user. In some embodiments, the current resource metric set may include (i) a user account metric set and (ii) a user contribution metric set, each of which is described in further detail below.

The user account metric set may include one or more user account metrics for one or more user accounts. The one or more user account metrics may be indicative of a current account value for a particular user account. For example, a user may have a 401(k) user account with a total of $100,000. As such, a user account metric for the 401(k) user account may be $100,000. As another example, a user may have a credit card user account with a balance of $1000. As such, the user account metric for the credit card user account may be −$1000 due to balance associated with the user account and the type of user account. Additionally, in some embodiments, user account metrics may further include one or more user account parameters that are applicable to the particular account. The particular user account parameters may vary between different type of users accounts. For example, user account metrics for a savings user account may include an annual percentage yield (APY) user account metric, a minimum required balance user account metric, a monthly fee user account metric, an external transfer cost user account metric, etc. In contrast, user account metrics for a credit card user account may include an annual percentage rate (APR) user account metric, a cash advance APR user account metric, a maximum credit limit user account metric, an available balance user account metric, a minimum balance due user account metric, a payment due date user account metric, and/or the like. Other user account metrics may include a loan term user account metric, a dividend user account metric, an interest paid to date user account metric, a fee user account metric, a remaining principal amount user account metric, historical return on investment (ROI) user account metrics, and/or the like.

As described above, the user contribution metric set may include one or more user contribution metrics for one or more contribution fields over a particular time frame of interest. A contribution field may a particular financial contribution category type and may further be associated with particular limits, rules, and/or regulations. For example, a contribution field may be a 401(k) contribution field which may be associated with a maximum annual contribution limit of $22,500 for those younger than 50 years old and a maximum annual contribution $30,000 for those 50 years old and older. Another contribution field may be a health savings account (HSA) contribution field which may be associated with a maximum annual contribution limit of $4,150 for an individual, a maximum annual contribution limit of $8,300 for a family, and additional have a rule set that allows users 55 years old and older to contribute an additional $1000. As yet another example, a contribution field may be a 529 plan contribution field which may not have a maximum annual contribution limit. However, the 529 plan contribution field instead be associated with a maximum of $17.000 per individual or a maximum of $85,000 over a five-year period that is not associated with a gift tax but may allow for contributions over these amounts (e.g., which are then subject to the gift-tax). Other contribution fields may include a flexible spending account (FSA) contribution field, an individual retirement account (IRA) contribution field, a social security contribution field, and/or the like.

In some embodiments, contribution fields may additionally include accounts which are associated with user liabilities, such as a credit card contribution field, a loan contribution field (e.g., a student loan contribution field, a mortgage contribution field, an auto contribution field, etc.), and/or the like. Contribution fields associated with user liabilities may be subject to limits imposed by the particular account. For example, a particular credit card account may be associated with a credit limit or a particular loan account may be associated with a particular maximum loan amount. As such, each user liability account may be associated with its own contribution field that is associated with the corresponding limits for the particular account.

In some embodiments, a user contribution metric may be indicative of an amount the user has contributed to a particular contribution field and may further be indicative of contribution limits, if applicable. For example, a user who has contributed $18,000 to a 401(k) contribution field may be associated with user contribution metrics of $18,000 annual contribution to-date and 80% annual contribution to-date, indicating that the user has contributed $18,000 to his/her 401(k) and has contributed 80% of the contribution limit. In some embodiments, the user contribution metric may be determined based on one or more user account metrics for the one or more user accounts that correspond a particular contribution field.

In some embodiments, a contribution field may be associated with one or more user accounts. For example, a user may have three 401(k) accounts. As such, user contribution metrics may factor in all accounts associated with a certain contribution field. For example, a user who has contributed $10,000 to a first 401(k) account and $8,000 to a second 401(k) account, and $0 to a third 401(k) account may be associated with user contribution metrics of $18,000 annual contribution to-date and 80% annual contribution to-date, indicating that the user has contributed $18,000 across his/her 401(k) accounts and has contributed 80% of the contribution limit.

In contrast to the user contribution metric set, the user account metric set may be indicative of the current account value of individual user accounts rather than an aggregate contribution value across accounts of a certain contribution type. By including both the user contribution metric set and user account metric set, the current resource metric set may provide a comprehensive overview of the individual and aggregate status of user accounts that allows user evaluation circuitry 208 to perform more robust analyses for the user.

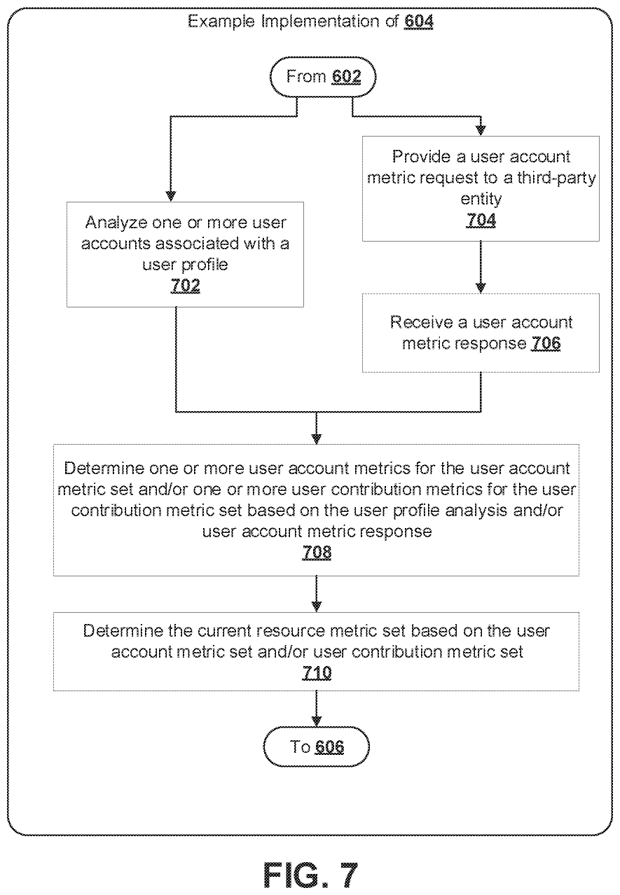

In some embodiments, operation 604 may be performed in accordance with the operations described by FIG. 7. Turning now to FIG. 7, example operations are shown for determining one or more user account metrics and/or one or more user contribution metrics.

Optionally, as shown by operation 702, the apparatus 200 includes means, such as processor 202, memory 204, communications hardware 206, user evaluation circuitry 208, and/or the like, for analyzing one or more user accounts associated with a user profile. For example, apparatus 200 may be operated by a financial institution and the user may have a checking user account, a savings user account, and a loan user account with the financial institution. The user evaluation circuitry 208 may analyze the user profile to identify one or more user accounts associated with the user. In some embodiments, the user evaluation circuitry 208 may identify user accounts that the user is not the primary account holder but is still listed on the user account, such as in a joint user account or a custodial user account. Alternatively, the user may be listed as a beneficiary or secondary account holder on an account.

Additionally, or alternatively, as shown by operation 704, the apparatus 200 includes means, such as processor 202, memory 204, communications hardware 206, and/or the like, for providing a user account metric request to a third-party entity. The user may additionally or alternatively have user accounts with an entity other than the entity operating apparatus 200. Because the user account is hosted with a different entity, apparatus 200 may not have instant access to third-party user accounts. However, it may be desirable to consider these external accounts when generating the resource allocation recommendation for the user. As such, in some embodiments, the user may provide apparatus 200 with access to the one or more third-party user accounts. For example, during an initial registration with the entity operating apparatus 200, the user may be prompted to list his/her external user accounts such that external account information may be collected and stored in the user profile. This account information may include the third-party entity the user account is with, a user account identifier (e.g., a user account number), and authorization credentials needed to access the external account (e.g., a username and password or other credentials). In some embodiments, authorization credentials are associated with only a limited account access such that the apparatus 200 may be limited to only obtaining certain user account data (e.g., user account metrics and/or pertinent supplemental data) but may not be authorized to perform any additional actions. As such, the security of the external user account may be maintained. Additionally, any sensitive or private information (e.g., an account identifier and/or provided credentials) may be stored securely in the corresponding user profile, such as by encrypting or tokenizing the information.

When determining the current resource metric set, the apparatus 200 may identify the identity of third-party entity and decrypt the corresponding account identifier (e.g., a user account number) and authorization credentials from the user profile and may then provide an account metric request to a third-party computing entity associated with the third-party entity. The account metric request may include the account identifier for the user and the authorization credentials for the user account as well as a request for one or more user account metrics for the corresponding user account. The apparatus 200 may generate the user account metric request and provide the user account metric request to the corresponding third-party device using the communications hardware 206. The recipient third-party computing may then use the provided account identifier to identify the one or more accounts for the user and may verify the provided authorization credentials to verify the validity of the account metric request.

In some embodiments, the communications hardware 206 may provide the account metric request to a third-party computing entity, such as any one of the third-party computing entities 108A-108N. In some embodiments, apparatus 200 may be configured to store or use a table or a list of verified third-party entities and a third-party entity address (e.g., a uniform resource locator (URL), internet protocol (IP) address, email, media access control (MAC) address, and/or the like) that may be used to initiate communication with verified third-party computing entities. The apparatus 200 may use the list to determine a particular address and/or third-party computing entity to send the account metric request. As such, the apparatus 200 may maintain the security of the external user account data by only providing the account metric request to verified third-party addresses.

As shown by operation 706, the apparatus 200 includes means, such as processor 202, memory 204, communications hardware 206, and/or the like, for receiving a user account metric response. The communications hardware 206 may receive an account metric response from the third-party entity in response to the provision of the account metric request. The account metric response may include the one or more user account metrics for the one or more user accounts of the user associated with the third-party entity. The user account metric response may be received from a third-party device, such as any one of third-party devices 108A-108N.

As shown by operation 708, the apparatus 200 includes means, such as processor 202, memory 204, communications hardware 206, user evaluation circuitry 208 and/or the like, for determining one or more user account metrics and/or user contribution metrics for the user based on the analysis of the one or more user accounts associated with the user profile and/or a user account metric response. In some embodiments, the user evaluation circuitry 208 may determine the one or more user account metrics based on the analysis of the user accounts and/or the account metric response. In some embodiments, the user evaluation circuitry 208 may then use the one or more user account metrics to determine the one or more contribution metrics, as described in greater detail below.

In an instance in which the one or more user accounts associated with the user profile were analyzed, the user evaluation circuitry 208 may directly determine one or more user account metrics for each user account based on the currently stored information for each user account. For example, an analysis of the user account may allow the user evaluation circuitry 208 to identify one or more user account metrics, such as a current account value.

Additionally, the user evaluation circuitry 208 may identify an account type for each of the one or more identified accounts. The user evaluation circuitry 208 may then determine one or more user account metrics for the one or more user accounts based on the account type and a stored set of user account metrics for the particular account type. The stored set of user account metrics for the particular account type may be stored in an associated memory, such as memory 204. The user account metrics included in the store set of user account metrics may be common amongst all user accounts of the particular account type. For example, a 0.4% APY value for a high-interest savings user account may be a user account metric that is common amongst all high-interest savings user account offered by the entity associated with apparatus 200.

In an instance in an account metric response was received, the user evaluation circuitry 208 may determine the one or more user account metrics based on the one or more user account metrics included in the account metric response. In some embodiments the user evaluation circuitry 208 may additionally perform a search or query, such as by using web-crawlers, to identify one or more additional user account metrics for a particular user account type offered by the third-party entity. For example, a user may have a high-interest savings user account with a third-party entity and the third-party entity may advertise a particular APY on an associated website. The user evaluation circuitry 208 may use a web-crawler to identify the particular APY offered by the third-party for the high-interest savings user account and determine a user account metric based on the results of the query. As such, the user evaluation circuitry 208 may supplement the user account metrics provided by the account metric response with additional user account metrics from the query to provide a more comprehensive analysis of the particular third-party user account, if needed.

Once the user evaluation circuitry 208 has determine the one or more user account metrics for the one or more user accounts, the user evaluation circuitry 208 may then determine the one or more user contribution metrics based on the one or more user account metrics. In particular, the user evaluation circuitry 208 may identify the one or more user accounts as corresponding to a particular contribution field. The user evaluation circuitry 208 may identify the appropriate contribution field for a user account based on the type of user account. For example, a user may have a 401(k) user account and an IRA user account. While both a 401(k) user account and IRA user account may be retirement savings accounts, the 401(k) user account may be identified as corresponding to a 401(k) contribution field while the IRA user account may be identified as corresponding to an IRA contribution field as these particular types of user accounts are subject to different limits, rules, and regulations. In some embodiments, a user account may not be associated with a contribution field. This may apply to user accounts that are not subject to contribution limits or other imposed limits.

Once the user evaluation circuitry 208 has identified a contribution field for the one or more user accounts, the user evaluation circuitry 208 may determine the one or more user contribution metrics for each contribution field based on the one or more user account metrics associated with each user account associated with the contribution field. In some embodiments, user account metrics corresponding to the same user account metric type may be summed together to yield a user contribution metric. For example, a user may have three 401(k) user accounts. The user evaluation circuitry 208 may identify an $10,000 annual contribution user account metric for the first 401(k) user account, an $8,000 annual contribution user account metric for the second 401(k) user account, and $0 annual contribution user account metric for the third 401(k) user account. The user evaluation circuitry 208 may then determine an $18,000 annual contribution to-date user contribution metric for a 401(k) contribution field.

As shown by operation 710, the apparatus 200 includes means, such as processor 202, memory 204, communications hardware 206, user evaluation circuitry 208 and/or the like, for determining the current resource metric set for the user based on the user account metric set and/or user contribution metric set. The current resource metric set may include the user account metric set and a user contribution metric set. As such, the current resource metric set may provide a comprehensive overview of an individual status of user accounts with the user account metric set and an aggregate status of user accounts in view of certain contribution fields with the user contribution metric set. As such, the user evaluation circuitry 208 may be configured to perform more robust analyses for the user as compared to other conventional methods.

Returning now to FIG. 6, as shown by operation 606, the apparatus 200 includes means, such as processor 202, memory 204, communications hardware 206, user evaluation circuitry 208 and/or the like, for generating a resource allocation recommendation message. The user evaluation circuitry 208 may generate the resource allocation recommendation message based on the predicted liquid asset influx and the current resource metric set. The resource allocation recommendation message may include one or more resource allocation recommendations that each are associated with (i) a user account of the one or more user accounts associated with the user or a new user account type and (ii) a resource allocation value. For example, a resource allocation recommendation may be associated with a particular auto loan user account that currently exists for the user. The resource allocation recommendation may further be associated with a resource allocation value that is indicative of an amount of funds that is recommended to be allocated to the particular auto loan. The resource allocation value may be a value between a minimum defined value (as set by a set of rules described in more detail below) and a total amount defined by the predicted liquid asset influx. As such, the resource allocation recommendation message may include multiple resource allocation recommendations that are associated with a resource allocation value that corresponds to a portion of the predicted liquid asset influx.

In some embodiments, the user evaluation circuitry 208 may use a resource allocation determination model to generate the resource allocation recommendations. The resource allocation determination model may be a rules-based model or a machine learning model (e.g., a neural network) that is configured to process the current resource metric set and the predicted liquid asset influx to determine one or more resource allocation recommendations for the user. In some embodiments, the resource allocation determination model may use one or more statistical techniques to generate the one or more resource allocation recommendations. In some embodiments, the statistical techniques may include a cost-effectiveness analysis (CEA), a negative predictive value (NPV) analysis, positive predictive value (PPV) analysis, etc.

In some embodiments, the resource allocation determination model may further be configured to process additional information, such as user input in order to determine the one or more resource allocation recommendations. In some embodiments, the user input may be obtained from the user profile of the user. This user input may be collected from the user during certain interaction periods (e.g., during registration of a user account, at periodic intervals, etc.). For example, user input may indicate personal goals and/or values for the user. By way of particular example, user input may indicate the user desires to save $5000 for a vacation within the next five years. As another particular example, the user input may indicate the user wants to prioritize paying off his/her debt. In some embodiments, the user evaluation circuitry 208 may be configured to access a user profile and obtain this information such that it may be provided to the resource allocation determination model.

In some embodiments, the resource allocation determination model may be trained using historical data that describes user attribute data, historical liquid asset data, an allocation of the historical liquid asset data, determine an inferred user benefit for the user based on the allocation, and/or determine an inferred user risk for the liquid asset allocations. As such, the resource allocation model may be configured to weight an inferred user benefit against an inferred user risk for candidate resource allocation recommendations. In some embodiments, the resource allocation determination model may be configured with a particular set of rules that it must also consider when determining the candidate resource allocation recommendations. For example, the set of rules may set a maximum and/or minimum number of candidate resource allocation recommendations, a maximum and/or minimum portion or value of a predicted liquid asset influx, an account type limitation, and/or the like. As such, the resource allocation determination model may be configured to operate within the rules defined by the set of rules to generate one or more resource allocation recommendations.

Additionally, the resource allocation model may be configured to process the information provided by the current resource metric set, which may be indicative of user account metrics for currently existing user accounts associated with the user and/or user contribution metric for one or more contribution fields. In some embodiments, the resource allocation determination model may also be configured to consider new accounts corresponding to an account type for the user. For example, if the user is not currently associated with a high-interest savings account, the resource allocation model may be configured to determine an inferred user benefit and inferred user cost for opening a new high-interest savings account for the user. As such, the resource allocation determination model is not limited to consideration of only the current user accounts and associated metrics and is instead allowed to contemplate additional scenarios such that the one or more resource allocation recommendations are further optimized for the user.

In some embodiments, the resource allocation determination model may additionally output one or more contributing factors that lead to the resource allocation recommendation. For example, a resource allocation recommendation may be indicative to contribute a portion of the predicted liquid asset influx into a high-interest savings account of the user. The resource allocation determination model may additionally provide an indication that the largest contributing factor that led to the resource allocation recommendation may be the consideration of a user input indicating the user wants to save for a vacation. This rationale or reasoning for the resource allocation recommendation may be output as supplemental information by the resource allocation determination model and the supplemental information may be optionally included in the resource allocation recommendation message.

Optionally, as shown by operation 610, the apparatus 200 includes means, such as processor 202, memory 204, communications hardware 206, user evaluation circuitry 208 and/or the like, for generating a forecast resource metric set. In some embodiments, the user evaluation circuitry 208 may be further configured to generate a forecast resource metric set. The forecast resource metric set may include one or more forecast user account metrics that each correspond to a particular user account or contribution field. The user evaluation circuitry 208 may determine the one or more forecast user account metrics based on a corresponding user account metric or user contribution metric and a corresponding recommended resource allocation value. For example, a resource allocation recommendation may pertain to a user savings account and the user savings account may be associated with a $500 current balance user account metric, indicating that the particular user savings account has a balance of $500. The resource allocation recommendation may further be associated with a resource allocation value of $200, indicative that the user is advised to put $200 of the predicted liquid asset influx in the user savings account. As such, the user evaluation circuitry 208 may determine a forecast user account metric of $700 as the forecast balance for the user savings account. In some embodiments, the forecast user account metric set may be included in the resource allocation recommendation message.

As shown by operation 612, the apparatus 200 includes means, such as processor 202, memory 204, communications hardware 206, and/or the like, for providing the resource allocation recommendation message. Once the user evaluation circuitry 208 has generated the resource allocation recommendation message, the communications hardware 206 may provide the resource allocation recommendation message to the user, such as via a corresponding user device (e.g., any one or user devices 106A-106N). The resource allocation recommendation message may further be formatted in any suitable communication format, such as via email, SMS text, via an associated application, etc. In some embodiments, the resource allocation recommendation message may be stored in a user profile associated with the user. In some embodiments, in an instance in which a user logs an associated user account, such as via a user device, the resource allocation recommendation message may be displayed to him/her via within his/her user account.

Optionally, as shown by operation 612, the apparatus 200 includes means, such as processor 202, memory 204, communications hardware 206, and/or the like, for receiving a resource allocation recommendation authorization from the user. In some embodiments, the user may interact with the resource allocation recommendation message, such as by selecting one or user inputs (e.g., a “yes” or “no” button associated with each resource allocation recommendation). In an instance in which the interaction between the user and the resource allocation recommendation message is affirmative or otherwise indicative the user wishes to proceed with a particular resource allocation recommendation, the communications hardware 206 may receive the resource allocation recommendation authorization. In some embodiments, the resource allocation recommendation may include authorization for only a subset of the resource allocation recommendations provided in the resource allocation recommendation message. For example, a resource allocation recommendation message may include two resource allocation recommendations but the user may only provide affirmative user input for one of the resource allocation recommendations. As such, the resource allocation recommendation authorization may only include the resource allocations to which the user has explicitly provided affirmative user input.

Optionally, as shown by operation 614, the apparatus 200 includes means, such as processor 202, memory 204, communications hardware 206, user evaluation circuitry 208 and/or the like, for causing an automatic re-allocation of the predicted liquid asset influx based on the one or more resource allocation recommendations. The user evaluation circuitry 208 may cause the automatic re-allocation of the predicted liquid asset influx in response to receipt of the resource allocation recommendation authorization. In particular, the user evaluation circuitry 208 may cause the automatic re-allocation of a portion of the predicted liquid asset influx equivalent to a resource allocation value for a corresponding resource allocation recommendation. In some embodiments, the user evaluation circuitry 208 may continuously monitor for a predicted asset influx to arrive in an associated user account (e.g., a user account associated with a direct deposit) and may automatically re-allocate the portion of the predicted liquid asset influx equivalent to the resource allocation value to an account described by the resource allocation recommendation.

As such, the system may automatically reallocate the predicted liquid asset influx funds to corresponding accounts such that the user does not need to continuously monitor his/her account. In doing so, example embodiments disclosed herein may allow for real-time re-allocation of a portion of a predicted liquid asset influx. In some embodiments, the user evaluation circuitry 208 may suspend conventional processing of the predicted liquid asset influx for the user account and instead, automatically reroute the portion of the predicted liquid asset influx based on the resource allocation recommendation(s), where the funds may then be processed and cleared. Thus, the automatic re-allocation of the predicted liquid asset influx may improve the process of asset transfer by reducing overall processing requirements and thus, conserving overall computational resources.

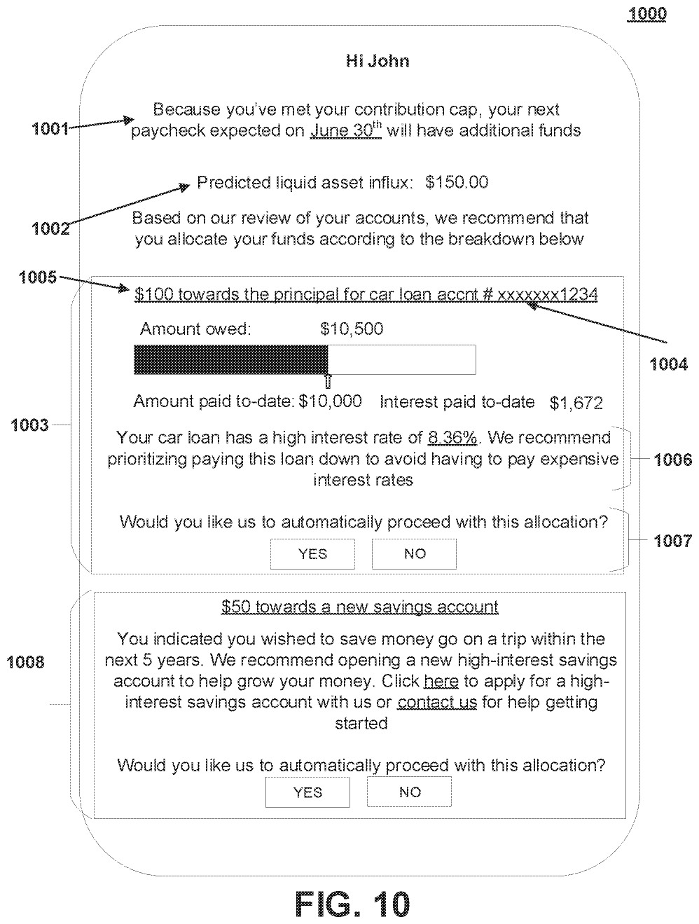

Turning to FIG. 10, a GUI is provided that illustrates an example resource allocation recommendation message. As noted previously, a user may interact with the predictive analysis system 102 by directly engaging with communications hardware 206 of an apparatus 200. In such an embodiment, the GUI shown in FIG. 10 may be displayed to a user by the apparatus 200. Alternatively, a user may interact with the predictive analysis system 102 using a separate user device (e.g., any of user devices 106A through 106N, as shown in FIG. 1), which may communicate with the predictive analysis system 102 via communications network 104. In such an embodiment, the GUI shown in FIG. 10 may be displayed to the user by the corresponding user device.

As shown by FIG. 10, the resource allocation recommendation message 1000 may provide the user with an indication of the event and event time frame 1001 and a predicted liquid asset influx 1002, similar to the asset savings notification. Additionally, the resource allocation recommendation message 1000 may include a resource allocation recommendation 1003 and resource allocation recommendation 1008. The resource allocation recommendation 1003 may include the user account associated 1004 with the resource allocation recommendation 1003 as well as the resource allocation value 1005 associated with the resource allocation recommendation 1003. Supplemental information 1006 may also be included in the resource allocation recommendation 1003 such that the user may be made aware of the reasoning for the recommendation. Additionally, the user may interact with the resource allocation recommendation 1003 via user inputs 1007. An affirmative interaction with a user input 1007 (e.g., selection of the “yes” user input) may cause a resource allocation recommendation authorization to be provided to the apparatus 200.

FIGS. 3-7 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### CONCLUSION

As described above, example embodiments provide methods and apparatuses that enable improved methods for identifying future user events and providing the user with relevant predicted event details and recommendations. In particular, example embodiments allow for the generation and provision of an asset savings notification to a user such that the user may be provided with an indication of a predicted event, a corresponding event time frame, and a predicted liquid asset influx indicative of a predicted amount of funds that correspond to the event. In this way, users may be made aware of incoming funds and may be able to effectively plan for receipt of these funds. In some embodiments, users may provide instructions to preemptively allocate the predicted liquid asset influx to a particular user account or create a new user account for the predicted liquid asset influx. As such, the user may optimize the benefit provided by the predicted liquid asset influx by rerouting these select funds from a default account (e.g., the account associated with direct deposit) to an account of the user's choosing. In some example embodiments, the user may be provided with the asset savings notification prior to the predicted event occurring. As such, the user may be provided additional time to plan how to use and/or reroute the predicted liquid asset influx to best serve his/her needs.

Additionally, example embodiments may be uniquely positioned to leverage various sources of data, such as an individual user's data (e.g., internal source data), employer organization data (e.g., organization attributes), and/or other employee data (e.g., a similar user subset), to determine a user event prediction and a predicted liquid asset influx for the event. By leveraging these various data sources, the event prediction accuracy and/or predicted liquid asset influx accuracy may be increased such that the user may be provided with an overall more accurate asset savings notification. Additionally, the user internal source data may allow for the identification of an employer organization of the user. Example embodiments disclosed herein may further identify employer organization attributes that may be used to determine the user event prediction and/or predicted liquid asset influx. Additionally, or alternatively, one or more other users associated with the employer organization may be identified. A similar user subset may be identified from the one or more other user and the data associated with the similar user subset may be anonymized and used to determine the user event prediction and/or predicted liquid asset influx. A similar user subset may include one or more users who are selected from a set of other users associated with the same employer organization as the user. In particular, users from the similar user subset may include users who share at least one user attribute with the user of interest. As such, the similar user subset may narrow down the number of users from all users within an employer organization to only users who are determined to be similar to the user of interest, thereby reducing associated computational processing requirements while maintaining prediction accuracy.

Additionally, in some example embodiments, it may be advantageous to provide a user with a resource allocation recommendation. A resource allocation recommendation may provide users with recommendations on how to optimize their predicted liquid asset influx such that the user may alleviate the analysis of how to optimize the allocation of the predicted liquid asset influx. In some example embodiments, supplemental information may be generated for the resource allocation recommendation, which may provide the user with an explanation of why a particular allocation of a portion of the funds of the predicted liquid asset influx was determined to be optimal for a particular account. As such, the user may gain additional insights into why a particular recommendation was determined. Additionally, a forecast resource metric set may also be determined for the user based on the resource allocation recommendation. The forecast resource metric set may provide the user with a prediction of how his/her accounts may be influenced or affected should the user choose to follow the resource allocation recommendation.

Additionally, embodiments disclosed herein may cause one or more predictive actions to take place. In some example embodiments, a predictive action may be monitoring for the predicted liquid asset influx within a user account on behalf of the user and automatically re-allocating portions of the predicted liquid asset influx to corresponding accounts as outlined in the resource allocation recommendation. In particular, a user may provide authorization and/or feedback that grants the system permission to follow the resource allocation recommendation. As such, the system may automatically reallocate the predicted liquid asset influx funds to corresponding accounts such that the user does not need to continuously monitor his/her account. In doing so, example embodiments disclosed herein may allow for real-time re-allocation of a portion of a predicted liquid asset influx. In some embodiments, the re-allocation of a portion of a predicted liquid asset influx may allow the system to bypass conventional processes of first clearing and processing a payment transfer to an original account and may instead, re-route portions of the predicted liquid asset influx to the appropriate accounts automatically, where they then may be processed and cleared. Thus, embodiments described herein may improve the process of asset transfer by reducing overall processing requirements and thus, conserving overall computational resources.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method for providing a resource allocation recommendation message to a user, the method comprising:
identifying, by user evaluation circuitry, a predicted liquid asset influx that is associated with the user, wherein the predicted liquid asset influx is also associated with an event time frame;
determining, by the user evaluation circuitry, a current resource metric set, wherein the current resource metric set comprises a user account metric set and a user contribution metric set;
generating, by the user evaluation circuitry and based on the predicted liquid asset influx and the current resource metric set, the resource allocation recommendation message, wherein the resource allocation recommendation message comprises one or more resource allocation recommendations that are each associated with (i) a user account of the one or more user accounts associated with the user or a new user account type and (ii) a resource allocation value; and
providing, by communications hardware, the resource allocation recommendation message.

2. The method of claim 1, further comprising:
analyzing, by the user evaluation circuitry, one or more user accounts associated with a user profile that is associated with the user; and
determining, by the user evaluation circuitry and based on the analysis of the one or more user accounts, one or more user account metrics for the one or more user accounts associated with the user profile, wherein (i) the one or more user account metrics are included in the user account metric set and (ii) generating the one or more resource allocation recommendation is further based on the one or more user account metrics.

3. The method of claim 1, further comprising:
analyzing, by the user evaluation circuitry, one or more user accounts associated with a user profile that is associated with the user; and
determining, by the user evaluation circuitry and based on the analysis of the one or more user accounts, one or more user contribution metrics for one or more contribution fields, wherein (i) the one or more user contribution metrics are included in the user contribution metric set and (ii) generating the one or more resource allocation recommendations is further based on the one or more user contribution metrics.

4. The method of claim 1, further comprising;
providing, by the communications hardware, a user account metric request to a third-party entity; and
receiving, by the communications hardware, a user account metric response, wherein (i) the user account metric response includes one or more user account metrics for one or more user accounts of the user associated with the third-party entity, (ii) the one or more received user account metrics are included in the user contribution metric set, and (ii) generating the one or more resource allocation recommendations is further based on the one or more received user account metrics.

5. The method of claim 4, further comprising:
determining, by the user evaluation circuitry and based on the one or more received user account metrics, one or more user contribution metrics for one or more contribution fields, wherein (i) the one or more determined user contribution metrics are included in the user contribution metric set and (ii) generating the one or more resource allocation recommendations is further based on the one or more determined user contribution metrics.

6. The method of claim 1, wherein a total value of each recommended resource allocation value is equivalent to the predicted liquid asset influx.

7. The method of claim 1, wherein the one or more user accounts associated with the user comprise one or more of a savings user account, a checking user account, a credit card user account, a user investment account, or a user loan account.

8. The method of claim 1, further comprising:
generating, by the user evaluation circuitry, a forecast resource metric set, wherein (i) the forecast resource metric set comprises one or more forecast user account metrics, (ii) each forecast user account metric corresponds to a particular user account or contribution field, (iii) the one or more forecast user account metrics are determined based on a corresponding user account metric or user contribution metric and a corresponding recommended resource allocation value, and (iv) the resource allocation recommendation message further comprises the forecast resource metric set.

9. The method of claim 1, further comprising:
generating, by the user evaluation circuitry, supplemental information for the resource allocation recommendation, wherein the supplemental information is indicative of a reason for a resource allocation recommendation and (ii) the resource allocation recommendation message further comprises the supplemental information.

10. The method of claim 1, further comprising:
receiving, by the communications hardware, a resource allocation recommendation authorization from the user; and
causing, by the user evaluation circuitry and based on the one or more resource allocation recommendations, an automatic re-allocation of the predicted liquid asset influx.

11. An apparatus for providing a resource allocation recommendation message to a user, the apparatus comprising:
user evaluation circuitry configured to:
identify a predicted liquid asset influx that is associated with the user, wherein the predicted liquid asset influx is also associated with an event time frame,
determine a current resource metric set, wherein the current resource metric set comprises a user account metric set and a user contribution metric set,
generate, based on the predicted liquid asset influx and the current resource metric set, the resource allocation recommendation message, wherein the resource allocation recommendation message comprises one or more resource allocation recommendations that are each associated with (i) a user account of the one or more user accounts associated with the user or a new user account type and (ii) a resource allocation value; and
communications hardware configured to:
provide the resource allocation recommendation message.

12. The apparatus of claim 11, wherein the user evaluation circuitry is further configured to:
analyze one or more user accounts associated with a user profile that is associated with the user; and
determine, based on the analysis of the one or more user accounts, one or more user account metrics for the one or more user accounts associated with the user profile, wherein (i) the one or more user account metrics are included in the user account metric set and (ii) generating the one or more resource allocation recommendation is further based on the one or more user account metrics.

13. The apparatus of claim 11, wherein the user evaluation circuitry is further configured to:
analyze one or more user accounts associated with a user profile that is associated with the user; and
determine, based on the analysis of the one or more user accounts, one or more user contribution metrics for one or more contribution fields, wherein (i) the one or more user contribution metrics are included in the user contribution metric set and (ii) generating the one or more resource allocation recommendations is further based on the one or more user contribution metrics.

14. The apparatus of claim 11, wherein the communications hardware is further configured to:
provide a user account metric request to a third-party entity; and
receive a user account metric response, wherein (i) the user account metric response includes one or more user account metrics for one or more user accounts of the user associated with the third-party entity, (ii) the one or more received user account metrics are included in the user contribution metric set, and (ii) generating the one or more resource allocation recommendations is further based on the one or more received user account metrics.

15. The apparatus of claim 14, wherein the user evaluation circuitry is further configured to:
determine, based on the one or more received user account metrics, one or more user contribution metrics for one or more contribution fields, wherein (i) the one or more determined user contribution metrics are included in the user contribution metric set and (ii) generating the one or more resource allocation recommendations is further based on the one or more determined user contribution metrics.

16. The apparatus of claim 11, wherein a total value of each recommended resource allocation value is equivalent to the predicted liquid asset influx.

17. The apparatus of claim 11, wherein the one or more user accounts associated with the user comprise one or more of a savings user account, a checking user account, a credit card user account, a user investment account, or a user loan account.

18. The apparatus of claim 11, wherein the user evaluation circuitry is further configured to:
generate a forecast resource metric set, wherein (i) the forecast resource metric set comprises one or more forecast user account metrics, (ii) each forecast user account metric corresponds to a particular user account or contribution field, (iii) the one or more forecast user account metrics are determined based on a corresponding user account metric or user contribution metric and a corresponding recommended resource allocation value, and (iv) the resource allocation recommendation message further comprises the forecast resource metric set.

19. The apparatus of claim 11, wherein the user evaluation circuitry is further configured to:
generate supplemental information for the resource allocation recommendation, wherein the supplemental information is indicative of a reason for a resource allocation recommendation and (ii) the resource allocation recommendation message further comprises the supplemental information.

20. A computer program product for providing a resource allocation recommendation message to a user, the computer program product comprising at least one non-transitory computer-readable storage medium storing software instructions that, when executed, cause an apparatus to:
identify a predicted liquid asset influx that is associated with the user, wherein the predicted liquid asset influx is also associated with an event time frame;
determine a current resource metric set, wherein the current resource metric set comprises a user account metric set and a user contribution metric set;
generate, based on the predicted liquid asset influx and the current resource metric set, the resource allocation recommendation message, wherein the resource allocation recommendation message comprises one or more resource allocation recommendations that are each associated with (i) a user account of the one or more user accounts associated with the user or a new user account type and (ii) a resource allocation value; and
provide the resource allocation recommendation message.

21-40. (canceled)
